(19) United States
(12) Patent Application Publication
(10) Pub. No.: US 2026/0189570 A1
(43) Pub. Date: Jul. 2, 2026

(54) LIMITING ACCESS PRIVILEGES TO PROVIDE SECURE GROUP-BASED ACCESS TO ELECTRONIC APPLICATIONS

(71) Applicant: Microsoft Technology Licensing, LLC, Redmond, WA (US)

(72) Inventors: Alexander Geoffrey HOWELLS, Sammamish, WA (US); Andrew CALDWELL, Franklin, TN (US); Ivona Deborah Agnela FURTADO, Redmond, WA (US); Rama Mohan Rao DINTAKURTHI, Redmond, WA (US); Vishwa Shobhit SAHAY, Redmond, WA (US); Aryan LUTHRA, Seattle, WA (US); Haris MOHAMMAD, Kirkland, WA (US)

(21) Appl. No.: 19/006,524

(22) Filed: Dec. 31, 2024

(51) Int. Cl. H04L 9/40

(52) U.S. Cl. CPC H04L 63/104; H04L 63/101; H04L 63/20

(57) ABSTRACT

Privilege overreach is a security threat that occurs when users are granted excessive access to electronic applications without considering potential security risks. This threat can arise for several reasons such as lack of access control policies and tools, user role complexity, legacy systems with inherited user privileges, and gradual accumulation of unnecessary privileges. For example, when users change roles or take on additional responsibilities at a company, they may accumulate access rights to various electronic applications without shedding access rights for electronic applications associated with their previous roles, leading to a gradual increase in privileges that can result in privilege overreach. The present technology limits access privileges to provide secure group-based access to electronic applications by discovering active users, classifying groups, and prioritizing them. Applications from a directory and application sign-in data are read and analyzed, along with group membership data, to determine optimal groups allowed to access an application.

### BACKGROUND

This disclosure relates to limiting access privileges to provide secure group-based access to electronic applications.

Electronic information security can be provided by limiting access privileges to electronic applications, cloud based files, or other electronic data. Access privileges to electronic applications, cloud based files, or electronic data are often determined based on a user risk score, electronic application health reports (e.g., a summary that provides insights into the overall condition of an electronic application—which often includes user authentication security checks), or other similar information. Access privileges may also be determined based on whether a user who belongs to a specific group has anomalous privileges compared to others in the group.

### SUMMARY

Privilege overreach is a security threat that occurs when users are granted unnecessary or unneeded (e.g., based on a user's organizational roles and responsibilities) access to electronic applications without considering potential security risks. Studies have shown that a sizable percentage of data breaches are caused by misuse of privileged access to electronic applications. This security threat can arise for several reasons such as lack of access control policies and tools, user role complexity, legacy systems with inherited user privileges, and gradual accumulation of unnecessary privileges. For example, when users change roles or take on additional responsibilities at a company, they may accumulate access rights to various electronic applications without shedding access rights for electronic applications associated with their previous roles, leading to a gradual increase in privileges that can result in privilege overreach.

The following discussion is focused on electronic applications. However the described techniques may be applied to cloud based files, other electronic files, or any other electronic data where information security is important.

Excessive access (privilege overreach) can open the door to data breaches, operational downtime, compliance violations, security incidents, and fines. Often, access to electronic applications is granted to large user groups that include many users who do not actually need or use the electronic application. In the event of a compromised user login, for example, an attacker can gain access to all linked applications, systems, data sets, and environments the compromised user is permitted to access, highlighting the importance of granting access to electronic applications to specific groups of users to avoid unauthorized access to sensitive data and resources.

To avoid these risks, access to electronic applications are assigned to specific groups of users based on their roles and responsibilities, user activity, or group membership data (i.e., their need to access a specific electronic application). The present technology limits access privileges to provide secure group-based access to electronic applications by discovering active users, classifying groups of users, and prioritizing them. Electronic applications from a directory and application sign-in data are analyzed, along with group membership data, to determine optimal groups allowed to access an individual electronic application.

Some embodiments include a method for limiting access privileges to provide secure group-based access to an electronic application. The method comprises discovering a user space comprising users associated with the electronic application. The method comprises grouping the users into groups to form a group space, with the groups in the group space including the users from the user space (with individual groups comprising one or more users). The method comprises determining a set of optimal groups from the group space. The set of optimal groups comprises users permitted to access the electronic application. The set of optimal groups is determined by ordering the groups in the group space based on a total quantity of users in a group, a quantity of overprivileged users in the group (e.g., users who do not require access to the electronic application such as users who have more permissions or access rights to the electronic application than are necessary for current roles or responsibilities associated with the users), and a quantity of underprivileged users in the user space (e.g., users who require access to the electronic application but who are not in the group). A first group in the ordering is assigned to the set of optimal groups. The first group is removed from the group space and the users in the first group are removed from the user space. The one or more remaining groups are iteratively re-ordered, assigned, and removed from the group space, and their users are removed from the user space, after assignment and removal of the first group. The re-ordering, assigning, and removing of the one or more remaining groups from the group space proceeds iteratively until no remaining group breaches an access threshold or the user space is empty.

The access threshold is determined based on the total quantity of users in the group, the quantity of overprivileged users, and the quantity of underprivileged users. The ordering and the access threshold are also determined based on a penalty for the overprivileged users and a penalty for the underprivileged users.

In some embodiments, one or both of the penalty for the overprivileged users and the penalty for the underprivileged users based on a required level of security associated with the electronic application. For example, the penalty for the overprivileged users may be increased responsive to the electronic application requiring relatively high security compared to other electronic applications.

In some embodiments, the method comprises grouping users who remain in the user space after the iterative re-ordering, assigning, and removing; and who require access to the electronic application; into a group in the set of optimal groups, or into a new group in the set of optimal groups. In some embodiments, the method comprises listing the users who remain in the user space after the iteratively re-ordering, assigning, and removing; and who require access to the electronic application.

In some embodiments, the method comprises outputting one or more of: the set of optimal groups; the listing; and indications of risks associated with specific users or groups in the set of optimal groups. The risks are determined based on an overprivileged rate for the set of optimal groups or other information. The outputting is configured to guide generation of one or more new security groups for the electronic application.

In some embodiments, determining the set of optimal groups comprises filtering the groups in the group space based on predefined upper and lower group size thresholds prior to the ordering. This includes removing groups that exceed maximum upper size or fall below minimum lower size thresholds. The upper and lower size thresholds are determined based on historical usage data for the electronic application.

In some embodiments, the grouping is based on user data that indicates user membership in one or more preexisting administrative registers. The one or more preexisting administrative registers comprise group membership information and indicate electronic application access rights for the users.

In some embodiments, the users associated with the electronic application comprise one or more of users in one or more preexisting administrative registers associated with the electronic application; active users who have used the electronic application with a recent period of time; and users whose organizational roles and responsibilities are associated with the electronic application.

In some embodiments, the method comprises discovering changes in one or more of: the one or more preexisting administrative registers, the active users, and the user roles and responsibilities; and re-grouping the users based on the changes.

In some embodiments, the method comprises discovering one or more additional user spaces associated with one or more additional electronic applications in a directory; grouping users associated with the one or more additional electronic applications into additional groups to form one or more additional group spaces; and determining one or more additional sets of optimal groups whose users are permitted to access the one or more additional electronic applications; for limiting access privileges to provide secure group-based access to the one or more additional electronic applications.

In some embodiments, the method comprises determining and outputting one or both of: a percentage of users in the user space included in a group that is part of the set of optimal groups; and an overprivileged rate for the set of optimal groups.

In some embodiments, ordering the groups in the group space comprises scoring the groups in the group space based on the total quantity of users in a group, the quantity of overprivileged users in the group multiplied by a penalty for the overprivileged users, and the quantity of underprivileged users in the user space multiplied by a penalty for the underprivileged users.

In some embodiments, the penalty for the overprivileged users and the penalty for the underprivileged users is determined by: predefining a range of possible values for the penalty for the overprivileged users and the penalty for the underprivileged users; scoring the groups in the group space based on different combinations of the possible values for the penalty for the overprivileged users and the penalty for the underprivileged users; for the combinations of the possible values for the penalty for the overprivileged users and the penalty for the underprivileged users, evaluating the groups that would be in the set of optimal groups based on a total quantity of users from the user space in the groups that would be in the set of optimal groups, the quantity of overprivileged users in the groups that would be in the set of optimal groups, and the quantity of underprivileged users not in the groups that would be in the set of optimal groups; and determining the penalty for the overprivileged users and the penalty for the underprivileged users based on the evaluating such that a desired balance between the total quantity of users from the user space in the groups that would be in the set of optimal groups and overprivileged user minimization is achieved.

Some embodiments include a tangible, non-transitory, machine-readable memory storing instructions that, when executed by a data processing apparatus such as a processor, cause the data processing apparatus to perform one or more described operations.

Some embodiments include a system comprising one or more processors, memory, or other components. The memory stores instructions that, when executed by the one or more processors, effectuate one or more described operations.

### BRIEF DESCRIPTION OF THE DRAWINGS

The above-mentioned aspects and other aspects of the present techniques will be better understood when the present application is read in view of the following figures in which like numbers indicate similar or identical elements.

FIG. 1A is a logical-architecture block diagram that illustrates a system configured for limiting access privileges to provide secure group-based access to electronic applications.

FIG. 1B illustrates a second potential embodiment of the system shown in FIG. 1A.

FIG. 1C illustrates a third potential embodiment of the system shown in FIGS. 1A and 1B.

FIG. 1D illustrates a fourth potential embodiment of the system shown in FIG. 1A, FIG. 1B, and FIG. 1C.

FIG. 2 illustrates discovering a user space, grouping the users into groups to form a group space, and determining a set of optimal groups from the group space (whose users are permitted to access an electronic application).

FIG. 3 illustrates an example flow of operations performed by one or more of the systems shown in FIG. 1A-FIG. 1D.

FIG. 4 illustrates a practical example of over and under privilege penalty determination.

FIG. 5 illustrates a practical example of group ordering. In this example, groups are ordered based on scores.

FIG. 6 illustrates different example embodiments of a method for limiting access privileges to provide secure group-based access to electronic applications.

### DETAILED DESCRIPTION OF CERTAIN EMBODIMENTS

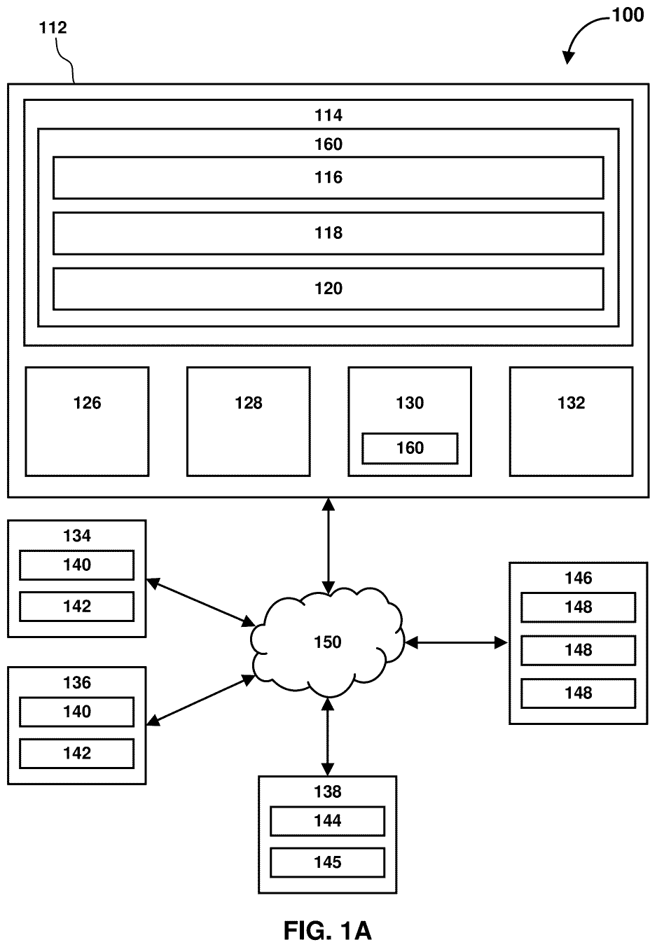

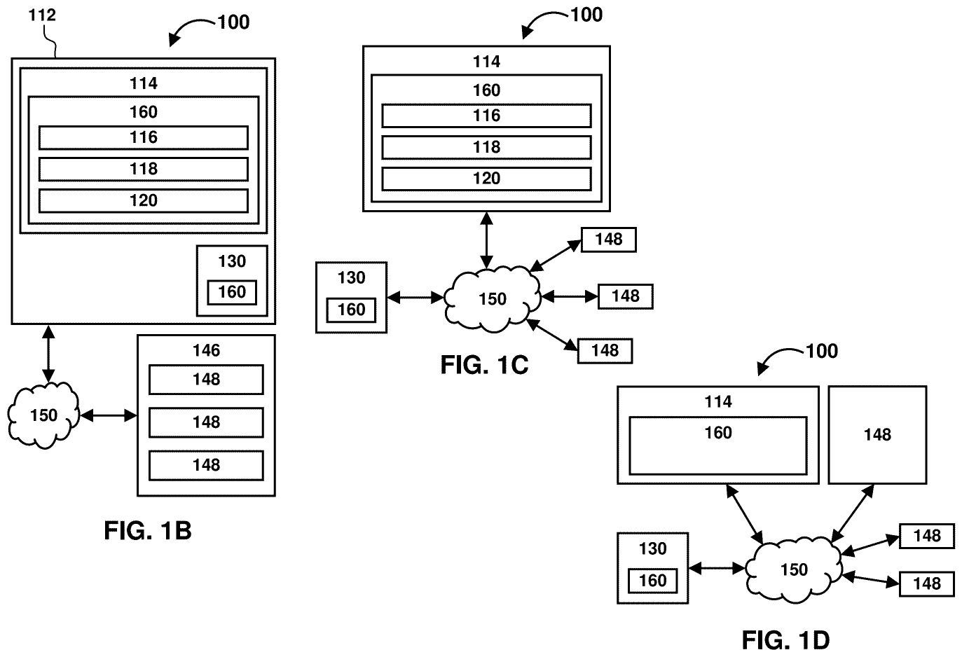

FIG. 1A illustrates a system 100 comprising a computing engine 112 and other components configured for limiting access privileges to provide secure group-based access to an electronic application (e.g., an “app”). An example app may include a company email application; a company messaging application; a human resources management app that provides access to sensitive data such as personal and payroll records; financial applications that provide access to budget, expense, sales, or other data; a customer relationship management app that provides access to customer and sensitive business information; and other electronic applications (e.g., “apps”). For example, apps like this contain or provide access to sensitive customer, financial, or employee data, making them prime targets for data breaches if overprivileged access is granted. Restricting access helps protect confidential information, ensures compliance with data protection regulations, and minimizes security risks, among other advantages. As described above, even though this description focuses on electronic applications, the described techniques may also or instead be applied to other electronic files and data (e.g., cloud based or shared files and data), or other electronic information that requires access security. For example, “electronic file” or “electronic data” might be substituted for the various mentions of “electronic application” in the discussion below.

In general, secure group-based access to an electronic application involves organizing users into groups, and determining whether a group of users should be granted permissions or access rights to a certain electronic application. As described below, groups of users are prioritized based on various factors to determine a set of optimal groups of users who are allowed to access the electronic application. Users are grouped based on data in one or more data sources which may include administrative registers or other data sources that describe which groups a user is already associated with, the users'organizational roles and responsibilities, or other information about users. The groupings are used to determine whether a user is allowed to access an electronic application. This functionality may be extended to determining what the user is allowed to do within an application, such as accessing certain features, viewing specific data, or performing particular actions, based on the described techniques.

System 100 provides a comprehensive approach to application access management. It goes beyond a user-level security focus. It identifies active users, determines groups, and analyzes risks, giving information technology administrators a clear view of application access privileges (e.g., for one or more different electronic applications or user groups). By evaluating sign-in data and group memberships among other data, system 100 identifies optimal groups of users who should be allowed to access a certain electronic application, reducing privilege excess, and streamlining access management. Advantageously, system 100 provides a complete solution to privilege overreach, ensuring access is granted to users who need it (and not to users who do not), minimizing unnecessary privileges, and guiding the creation of new security groups for enhanced protection.

Systems configured to limit access privileges to electronic applications exist. Conventional systems often address isolated aspects of access control, such as by user risk scores or app-specific privileges. Conventional systems also do not address application access management comprehensively. While some systems address security concerns at the user level, such as by using the user risk scores and app-specific privileges, along with application health reports, and recommended groups, these solutions typically address directory objects independently. For example, conventional systems may identify whether a user who belongs to a specific group has anomalous privileges compared to others, but they may not provide end-to-end access management recommendations for electronic applications by connecting multiple directory objects like groups, users, and applications. While this may address the issue of an anomalous user within a specific group, it does not resolve the challenge of ensuring a correct group has access to an application. Additionally, some of these groups may be small relative to an associated team or unit, so system 100 is configured to determine an optimal number of groups for application access. Further, conventional systems often lack the ability to dynamically adjust group memberships based on real-time user activity, leading to static access controls that can become outdated. Conventional systems also fail to offer comprehensive insights into the overall privilege landscape, resulting in blind spots for administrators regarding potential security risks and the necessity of new group formations.

Conversely, system 100 integrates multiple data sources and provides a holistic view of access management by linking user activities, group memberships, and application usage to optimize and securely streamline access permissions. System 100 focuses on the entire journey of managing access to applications (e.g., as described herein). System 100 provides several key advantages compared to conventional systems. Among these advantages are determining optimal user group assignments for electronic applications; ensuring that the right users have access to the right electronic applications; minimization of overprivilege; enhancing access management for application owners; provision of overprivileged rates and other characteristic information for various user groups or electronic applications; and identifying needs for new group creation.

“Overprivilege” or “overprivileged” is used to describe users who do not require access to an electronic application, such as users who have more permissions or access rights to the electronic application than are necessary for current roles or responsibilities associated with the users, but who nonetheless retain access to the electronic application. “Require” means to have a necessity for access to an electronic application in order to fulfill the current roles or responsibilities associated with a user, for example. This implies that access is necessary based on the practical usage or functional need tied to the user's role, as determined by analyzing user activity, group membership data, or other information as described herein. “Underprivilege” or “underprivileged” is used to describe users who require access to an electronic application but who are not in a group that has been granted access. System 100 determines whether someone is overprivileged by analyzing user activity data, such as sign-in records and application usage logs, to identify users who have access to an application but have not actively used it within a specified period (e.g., the past 90 days). Conversely, system 100 identifies underprivileged users by cross-referencing application usage data with group membership information to find users who frequently use the application but are not included in the groups that have been granted access.

“Optimal” is used to describe a desired balance between the total quantity of users granted access to an electronic application (e.g., the coverage), overprivileged users, and underprivileged users. Phrased another way, “optimal” refers to a desired balance between maximizing coverage of active users of an electronic application and minimizing unnecessary access, or balancing coverage with privilege minimization. The “set of optimal groups” is a selected set of groups of users (see further description below) that provides this balance between maximizing coverage of active users of an electronic application and minimizing unnecessary access. “Optimal,” and the set of optimal groups, may be different for different electronic applications (e.g., electronic applications that require a relatively higher security level compared to other electronic applications) or other scenarios. “Optimal” may depend on the specific security requirements and tolerance for overprivilege and underprivilege for a given electronic application. Relatively high security electronic applications may have a different set of optimal groups compared to relatively low security electronic applications, resulting in less overprivilege, for example. The set of optimal groups ensures that the most appropriate balance between coverage, overprivilege, and underprivilege is achieved for the given electronic application.

In these and other ways, system 100 provides technical solutions to technical problems related to efficiently and effectively limiting access privileges to electronic applications. System 100 provides a new structure (e.g., discovering active users, classifying groups, and prioritizing them - iteratively removing groups and users from an available remaining pool as prioritization progresses) that provides secure group-based access to the electronic applications. System 100 also improves human-computer interaction at least by reducing the burden on administrators to track and update electronic application access privileges based on changing roles and responsibilities within an organization, and increases computing efficiency by only providing access privileges to electronic applications to users who need them, and by reducing security incidents that require digital investigation, among other advantages.

For example, in a conventional approach, some systems simply identify whether a user who belongs to a specific group has anomalous privileges compared to others in the group (e.g., a user level security focus). This requires computing resources for a one by one evaluation of individual users, and does not necessarily identify different user access needs as the user's roles and responsibilities change within an organization.

Conversely, the present systems and methods are configured to discover active users of an electronic application, classify them into groups, and prioritize the groups to provide secure group-based access to the electronic application. The present systems and methods can be used to provide information technology (IT) administrators with details on application access and risks associated with specific users or groups that have access. The present systems and methods provide a unified approach to application access management by linking various directory elements such as users, groups, and applications—including by reading and analysis of many applications from a customer directory, along with application sign-in activity data, group membership data, and other data, to find optimal groups for individual applications for managing access.

More details related to the technical solution(s) provided by system 100 are described below, after introducing the components of system 100 and describing their operation. It should be noted, however, that not all embodiments necessarily provide all of the benefits outlined herein, and some embodiments provide all or a subset of these benefits or different benefits, as various engineering and cost tradeoffs are envisioned, which is not to imply that other descriptions are limiting.

System 100 includes computing engine 112, which may interact with mobile user devices 134 and 136, a desktop user device 138, external resources 146, or other systems. Interaction with users or other entities such as a company server (which may be represented by any of the computing devices shown in FIG. 1A, included in external resources, etc.) occurs via a website or a native application viewed on a desktop user device 138, a mobile user device 134 or 136, or other components. In some embodiments, interaction occurs via a desktop user device 138 such as a desktop computer, a mobile website viewed on a smart phone, tablet, or other mobile user device 134 or 136, or via a special-purpose native application executing on a smart phone, tablet, or other mobile user device. Limiting access privileges to provide secure group-based access to electronic applications across a variety of devices is expected to make it easier for users to request or receive desired information when and where convenient for the user, or have other advantageous effects.

In some embodiments, computing engine 112 includes one or more of a processor 114, an application program interface (API) server 126, a web server 128, a memory 130, and a cache server 132. These components, in some embodiments, communicate with one another in order to provide the functionality of computing engine 112 described herein.

To illustrate an example of the environment in which computing engine 112 operates, FIG. 1A includes a number of components with which computing engine 112 communicates: mobile user devices 134 and 136; a desktop user device 138; and external resources 146. These devices communicate with computing engine 112 via a network 150, such as the Internet or the Internet in combination with various other networks, like local area networks, cellular networks, Wi-Fi networks, or personal area networks.

Mobile user devices 134 and 136 comprise smart phones, tablets, gaming devices, or other hand-held networked computing devices having a display, a user input device (e.g., buttons, keys, voice recognition, or a single or multi-touch touchscreen), memory (such as a tangible, machine-readable, non-transitory memory), a network interface, a portable energy source (e.g., a battery), and a processor (a term which, as used herein, includes one or more processors) coupled to these components. The memory of mobile user devices 134 and 136 stores instructions that when executed by the associated processor provide an operating system and various applications, including a web browser 142, a native mobile application 140, or both. The desktop user device 138 also includes a web browser 144, a native application 145, or other electronic resources. In addition, desktop user device 138 includes a monitor; a keyboard; a mouse; memory; a processor; and a tangible, non-transitory, machine-readable memory storing instructions that when executed by the processor provide an operating system and the web browser 144 or the native application 145.

Native applications 140 and 145, and web browsers 142 and 144, in some embodiments, are operative to provide a graphical user interface associated with a user, for example, which communicates with computing engine 112 and facilitates user interaction with data from computing engine 112. In some embodiments, computing engine 112 is stored on or otherwise executed by user computing resources (e.g., a user computer, server, etc., such as mobile user devices 134 and 136, and desktop user device 138 associated with a user), servers external to the user, or in other locations. In some embodiments, computing engine 112 is run as an application (e.g., an app such as native application 140) on a server, a user computer, or other devices.

External resources 146 include sources of information such as databases, websites, etc.; external entities participating with system 100; one or more servers outside of system 100; a network (e.g., the internet); electronic storage; equipment related to Wi-Fi™ technology; equipment related to Bluetooth® technology; data entry devices; or other resources. External resources 146 include data sources 148. Data sources 148 may include one or more directories of electronic applications, application sign-in data for one or more of the electronic applications in a directory, group membership data for one or more of the electronic applications in a directory, data indicating active users who have used an electronic application within a recent period of time (e.g., with “active” indicating use within a day, a week, a month, a year, etc.), data that indicates users whose organizational roles and responsibilities are associated with an electronic application, data that indicates user membership in one or more preexisting administrative registers, the one or more preexisting administrative registers themselves, user access request logs, audit trails of access changes, security incident reports, compliance requirements, historical data on group access changes, or other data. The one or more preexisting administrative registers comprise group membership information and indicate electronic application access rights for the users. For example, in some embodiments, users associated with an electronic application comprise one or more of users in one or more preexisting administrative registers associated with the electronic application; active users who have used the electronic application with a recent period of time; and users whose organizational roles and responsibilities are associated with the electronic application; all of which information may be stored in one or more data sources 148.

Data sources 148 are those available to system 100 for searching or otherwise using to function as described. Data sources 148 may comprise a large and varying set of data sources, with many different types of data, access protocols, etc.. In some embodiments, data sources 148 comprise tabular data, graph data, data tables, columns of data, documents, charts, images, video, sensor data, or other data. Even though only a small number of data sources 148 are shown in FIG. 1A, these are intended to represent tens, hundreds, thousands, millions, or billions of different available data sources 148. In some embodiments, some or all of the different available data sources 148 are co-located (e.g., in a database server associated with a user), or individual available data sources 148 are located remotely from other data sources 148 (e.g., in different database servers associated with an organization and located across the world).

In some embodiments, some or all of the functionality attributed to external resources 146 is provided by resources included in system 100. External resources 146 are configured to communicate with computing engine 112, mobile user devices 134 and 136, desktop user device 138, or other components of system 100 via wired or wireless connections, via network 150 (e.g., a local area network or the internet), via cellular technology, via Wi-Fi technology, or via other resources.

Thus, computing engine 112, in some embodiments, operates in the illustrated environment by communicating with a number of different devices and transmitting instructions to various devices to communicate with one another. The number of illustrated external resources 146, desktop user devices 138, and mobile user devices 136 and 134 is selected for explanatory purposes only, and embodiments are not limited to the specific number of any such devices illustrated by FIG. 1A, which is not to imply that other descriptions are limiting.

Memory 130 stores instructions 160 that, when executed by processor 114, cause processor 114 to execute the various operations described herein. In some embodiments, memory 130 stores or is configured to access other data (e.g., data in one or more data sources 148 described above) required for limiting access privileges to provide secure group-based access to an electronic application, or other information that otherwise allows system 100 to function as described herein. In some embodiments, memory 130 includes various types of data stores, including relational or non-relational databases; image, document, etc., collections; or programming instructions for example. In some embodiments, such components are formed in a single database, or are stored in separate data structures. In some embodiments, memory 130 comprises electronic storage media that electronically stores information. In some embodiments, the electronic storage media of memory 130 includes one or both of system storage that is provided integrally (i.e., substantially non-removable) with system 100 or other storage that is connectable (wirelessly or via a wired connection) to system 100 via, for example, a port, a drive, a network (e.g., the Internet), etc.. In some embodiments, memory 130 is (in whole or in part) a separate component within system 100, or memory 130 is provided (in whole or in part) integrally with one or more other components of system 100 (e.g., processor 114). In some embodiments, memory 130 is located in a data center, in a server that is part of external resources 146, in a computing device 134, 136, or 138, or in other locations. In some embodiments, memory 130 includes one or more of optically readable storage media, magnetically readable storage media, electrical charge-based storage media (e.g., EPROM, RAM, etc.), solid-state storage media, or other electronically readable storage media. In some embodiments, memory 130 stores software algorithms, information determined by processor 114, information received via a graphical user interface displayed on computing devices 134, 136, or 138, information received from external resources 146 (e.g., data from a search of a data source 148), or other information accessed by system 100 to function as described herein.

Processor 114 is configured to coordinate the operation of the other components of computing engine 112 to provide the functionality described herein. In some embodiments, processor 114 is formed by two or more processors, for example. As shown in FIG. 1A, in some embodiments, instructions 160 comprise a grouping module 116, an optimization module 118, and an output module 120. Processor 114 is configured to direct the operation of modules 116, 118, or 120 by software; hardware; firmware; some combination of software, hardware, or firmware; machine-readable instructions; or other mechanisms for configuring processing capabilities.

Grouping module 116 is configured to discover a user space comprising users associated with the electronic application. The user space is the collective group of users associated with the electronic application. The user space can be thought of as the group of all individuals who interact with or need access to a particular software application within a company. It includes users who are currently using the application, those who have used it in the past, and those whose job roles require them to have access to the application. It can be likened to a list of everyone who has or should have permission to use a specific electronic application, based on their job responsibilities and past usage patterns, or other information.

Users being associated with an electronic application refers to some established electronic relationship between the users and the electronic application based on prior use, need, a user's roles or responsibilities within an organization, being part of a larger group of users that uses or has been granted access to the electronic application, or other information. Association may be based on user accounts or profiles within for an application, tracked usage history, access patterns, or other stored data linked to the user. For example, in some embodiments, the users associated with the electronic application comprise one or more of users in one or more preexisting administrative registers (e.g., stored in data sources 148) associated with the electronic application, active users who have used the electronic application with a recent period of time (e.g., a day, a month, a week, etc., determined based on data in data sources 148 or other information), users whose organizational roles and responsibilities are associated with the electronic application (e.g., again determined based on data in data sources 148), or other users.

Discovering a user space comprises identifying and accessing memory or other data storage resources (e.g., data sources 148) that store user-level information within a computing system. This process may include scanning for relevant data, querying an operating system for memory mappings, or identifying the data structures associated with user-level data. Discovering may include electronically retrieving this data. This may involve issuing system calls or utilizing APIs to retrieve data about users, such as identifiers and data stored based on these identifiers, previously assigned access permissions or groups, and other data.

An electronic application comprises a software-based program or system designed to perform specific functions or provide services when executed on a computing device. An electronic application may operate on various platforms, including desktop computers, mobile devices, embedded systems, web browsers, or in cloud-based environments. The application may interact with external systems, such as databases, APIs (application programming interfaces), or network services, to provide its functionality. An electronic application may be implemented as standalone software, a distributed system, or some combination thereof. For example, in some embodiments, the application may operate locally on a user's device, while in others, it may rely on communication with remote servers for processing or data access.

Users of an electronic application may include individuals or entities interacting with an electronic application to perform tasks, access information, or utilize its services. Users may vary in their roles, ranging from end users who engage directly with the application's interface to administrators responsible for configuring and managing the application's settings. Users may access the application through various devices as shown in FIG. 1A, and may interact with the application either online or offline depending on the implementation.

Grouping module 116 is configured to group the users into groups to form a group space, with individual groups in the group space including at least one user from the user space. An individual group comprises a collection of one or more users. The group space comprises a logical or virtual construct with users grouped into defined groups for the purpose of permissions, as described herein. The group space may serve as a framework for categorizing groups of users based on shared characteristics, such as organizational roles, memberships, or functional responsibilities. In some embodiments, the grouping is based on user data that indicates user membership in one or more preexisting administrative registers (e.g., stored in one or more data sources 148). The one or more preexisting administrative registers may comprise group membership information and indicate electronic application access rights for the users, for example.

In some embodiments, grouping module 116 is configured to discover changes in one or more of the one or more preexisting administrative registers, the active users, the user roles and responsibilities, or other information associated with the users in the user space, and re-group the users based on the changes. This may be programmed to occur at regular time intervals, instigated manually by a user, or performed at other intervals.

Optimization module 118 is configured to determine a set of optimal groups from the group space whose users are permitted to access an electronic application. The set of optimal groups is determined by optimization module 118 by ordering the groups in the group space based on a total quantity of users in a group (e.g., the coverage a group would provide), a quantity of overprivileged users in the group (e.g., users who do not require access to the electronic application such as users who have more permissions or access rights to the electronic application than are necessary for current roles or responsibilities associated with the users), and a quantity of underprivileged users in the user space (e.g., users who require access to the electronic application but who are not in the group). A first group in the ordering is assigned to the set of optimal groups by optimization module 118. The first group is removed from the group space and the users in the first group are removed from the user space. The one or more remaining groups are iteratively re-ordered, assigned, and removed from the group space, and their users are removed from the user space, after assignment and removal of the first group. Optimization module 118 is configured such that the re-ordering, assigning, and removing of the one or more remaining groups from the group space proceeds iteratively until no remaining group breaches an access threshold or the user space is empty.

The access threshold is determined by optimization module 118 based on the total quantity of users in the group (e.g., the coverage), the quantity of overprivileged users, and the quantity of underprivileged users. The ordering and the access threshold are also determined based on a penalty for the overprivileged users and a penalty for the underprivileged users. This access threshold represents a balance, where the combination of users in a group is optimized to minimize security risks, while ensuring necessary access. It takes into account the need to limit excessive access (overprivilege) and to provide required access (underprivilege) in a way that aligns with the security requirements of the electronic application. In some embodiments, optimization module 118 is configured such that one or both of the penalty for the overprivileged users and the penalty for the underprivileged users is based on a required level of security associated with the electronic application. For example, the penalty for the overprivileged users may be increased responsive to the electronic application requiring relatively high security compared to other electronic applications.

In some embodiments, optimization module 118 is configured to group users who remain in the user space after the iterative re-ordering, assigning, and removing; and who require access to the electronic application; into a group in the set of optimal groups, or into a new group in the set of optimal groups. In some embodiments, optimization module 118 is configured to simply list the users who remain in the user space after the iteratively re-ordering, assigning, and removing; and who require access to the electronic application (e.g., for output by output module 120).

In some embodiments, optimization module 118 is configured to filter the groups in the group space based on predefined upper and lower group size thresholds prior to the ordering. This includes removing groups with a number of users that exceed maximum upper size or a number of users that falls below minimum lower size thresholds. The upper and lower size thresholds are determined based on historical usage data for the electronic application or other information. An example of a historical usage data-based threshold determination involves analyzing past access patterns associated with the electronic application. For example, if historical data shows that groups with more than 50 users tend to have a higher incidence of security breaches or access issues, the upper size threshold can be set at 50 users. Conversely, if data indicates that groups with fewer than 5 users are often too small to justify their existence or lack sufficient coverage, the lower size threshold can be set at 5 users. These size thresholds help ensure that groups are neither too large to manage effectively nor too small to be useful. In general, the upper and lower size thresholds might vary depending on the specific application and its usage patterns. For example, a typical range could be: lower size threshold: 5 users; upper threshold: 50 users. However, for electronic applications with different security requirements or usage patterns, these numbers might be adjusted. For instance, a highly sensitive application might have stricter size thresholds, such as a lower size threshold of 10 users and an upper size threshold of 30 users, to ensure tighter control and security.

In some embodiments, optimization module 118 is configured such that ordering the groups in the group space comprises scoring the groups in the group space based on the total quantity of users in a group, the quantity of overprivileged users in the group multiplied by a penalty for the overprivileged users, and the quantity of underprivileged users in the user space multiplied by a penalty for the underprivileged users. In some embodiments, the penalty for the overprivileged users and the penalty for the underprivileged users is determined by predefining a range of possible values for the penalty for the overprivileged users and the penalty for the underprivileged users. The groups in the group space are scored based on different combinations of the possible values for the penalty for the overprivileged users and the penalty for the underprivileged users. For the combinations of the possible values for the penalty for the overprivileged users and the penalty for the underprivileged users, optimization module 118 evaluates the groups that would be in the set of optimal groups based on a total quantity of users from the user space in the groups that would be in the set of optimal groups, the quantity of overprivileged users in the groups that would be in the set of optimal groups, and the quantity of underprivileged users not in the groups that would be in the set of optimal groups. Optimization module 118 determines the penalty for the overprivileged users and the penalty for the underprivileged users based on this evaluation, such that a desired balance between the total quantity of users from the user space in the groups that would be in the set of optimal groups and overprivileged user minimization is achieved.

Output module 120 is configured to output (e.g., for display on one or more of the computing devices shown in FIG. 1A) one or more of: the set of optimal groups; the listing; and indications of risks associated with specific users or groups in the set of optimal groups. The risks are determined by optimization module 118 based on an overprivileged rate for the set of optimal groups or other information. The outputting by output module 120 is configured to guide generation of one or more new security groups for the electronic application. The one or more new security groups may be generated automatically by system 100, manually by an information technology administrator, or in other ways.

In some embodiments, output module 120 is configured to determine and output one or both of a percentage of users in the user space included in a group that is part of the set of optimal groups, and an overprivileged rate for the set of optimal groups. This information may be used by an information technology administrator, for example, to gage risks associated with unnecessarily providing access to an electronic application to users who do not need that access, balanced with ensuring that those who do need access have it, or for other purposes.

The operations performed by modules 116-120 may be repeated (e.g., simultaneously or in succession) for tens, hundreds, thousands, or more electronic applications. For example, in some embodiments, grouping module 116 is configured to discover one or more additional user spaces associated with one or more additional electronic applications in a directory (e.g., the directory being stored in a data source 148). Grouping module 116 is configured to group users associated with the one or more additional electronic applications into additional groups to form one or more additional group spaces. Optimization module 118 is configured to determine one or more additional sets of optimal groups whose users are permitted to access the one or more additional electronic applications (e.g., for limiting access privileges to provide secure group-based access to the one or more additional electronic applications).

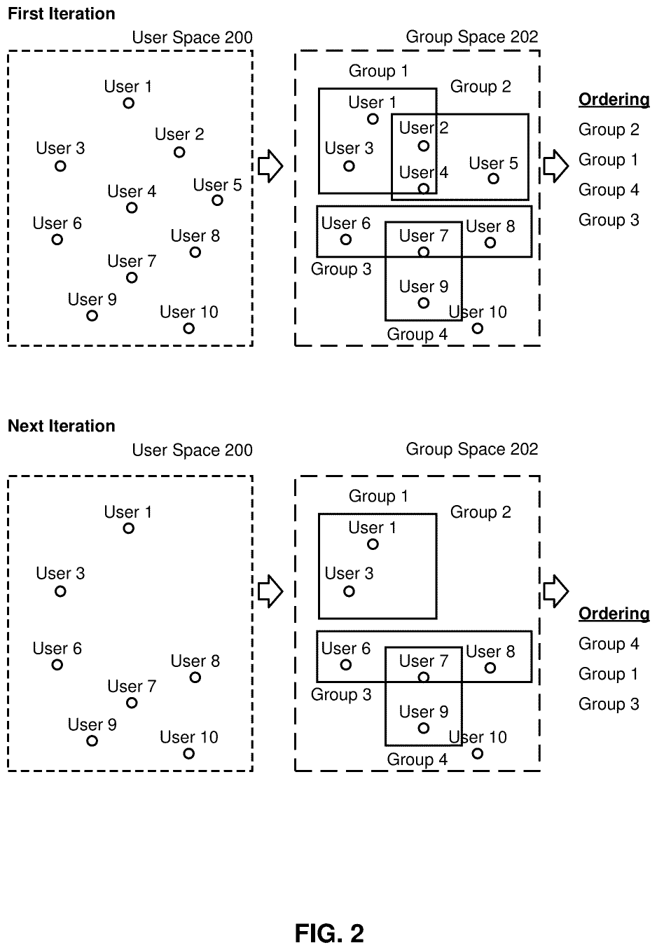

Several additional details related to the operations performed by modules 116-118 are illustrated in FIG. 2-5, and described below.

For example, FIG. 2 illustrates discovering a user space 200, grouping the users (Users 1-10 in this example) into groups (Groups 1-4 in this example) to form a group space 202, and determining a set of optimal groups from group space 202 (whose users are permitted to access an electronic application). An individual group (Group 1-4) in group space 202 includes at least one user (Users 1-10) from user space 200. Users may overlap between groups as shown in FIG. 2. In this example, Groups 1-4 are ordered (as described herein), and a first group in the ordering (Group 2 in this example) is assigned to a set of optimal groups (not shown in FIG. 2). Ordering Groups 1-4 in group space 202 is based on a total quantity of users in a group (e.g., coverage, anywhere between two and four users per group in this example), a quantity of overprivileged users in the group (e.g., users who do not require access to the electronic application such as users who have more permissions or access rights to the electronic application than are necessary for current roles or responsibilities associated with the users), a quantity of underprivileged users in the user space (e.g., users who require access to the electronic application but who are not in the group), or other information.

The one or more remaining groups (now forming a reduced size group space 202 with one less group) are iteratively re-ordered, assigned, and removed from group space 202, and their users are removed from user space 200, after assignment and removal of Group 2. As shown in FIG. 2, in the next iteration, Group 2 is removed from group space 202 and the users (Users 2, 4, and 5 in this example) in Group 2 are removed from user space 200 (compare group space 202 and user space 200 in the first and next iterations in FIG. 2). Re-ordering, assigning, and removing of the one or more remaining groups (Groups 1, 3, and 4 in this example) from the group space and their users from the user space (Users 1, 3, and 6-10 in this example) after assignment and removal of the first group continues to occur iteratively. The re-ordering, assigning, and removing of the one or more remaining groups from group space 202 proceeds iteratively until no remaining group breaches an access threshold (e.g., as described herein) or user space 200 is empty.

In some embodiments, optimization module 118 (FIG. 1A) is configured to group users (e.g., potentially User 10 in this example) who remain in user space 200 after the iterative re-ordering, assigning, and removing; and who require access to the electronic application; into a group in the set of optimal groups, or into a new group in the set of optimal groups. In some embodiments, User 10 may simply be listed on a list of users who remain in user space 200 after the iteratively re-ordering, assigning, and removing; and who require access to the electronic application (e.g., for output by output module 120 shown in FIG. 1A).

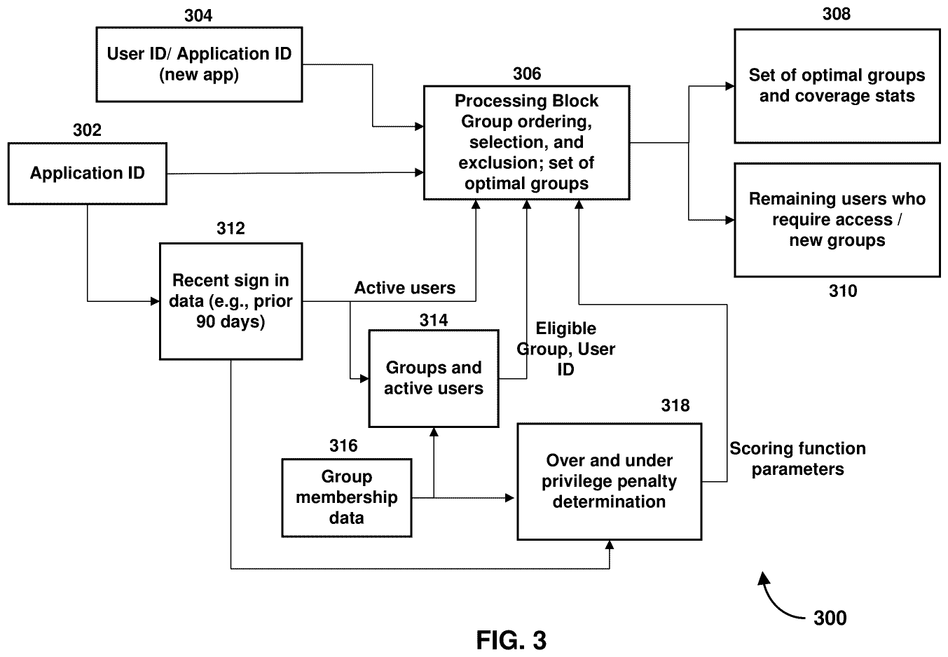

FIG. 3 illustrates an example flow 300 of operations performed by system 100 (FIG. 1A). As described above, and shown in FIG. 3, system 100 iterates through groups that include at least one active user of an electronic application, and orders the groups based on how well they cover the user space (the set of active users) and how much overprivilege they provide to certain users (e.g., users who are not actively using or needing to use an electronic application, but who still have access). Flow 300 comprises selecting the first group in the order (e.g., one with the highest score as described below, or some other indication of highest priority) and iteratively repeats this process until no more groups breach an access threshold, or the user space is empty. Flow 300 outputs the set of optimal groups, and the remaining users that need direct access to the electronic application (e.g., in a list or some other form) or assignment to a new group, among other possible information (e.g., as described herein).

As shown in FIG. 3, flow 300 begins with input 302 of an electronic application (identified by an application ID in this example) for which limiting access privileges and providing secure group-based access is desired. In some embodiments, flow 300 may begin with input 304 of user identifications of users who require access to a certain electronic application (e.g., for a new application). At processing block 306, various operations performed by processor 114 and modules 116-120 (FIG. 1A) are performed. For example, a user space is discovered comprising users associated with the electronic application. The users are grouped into groups to form a group space, with an individual group in the group space including at least one user from the user space. A set of optimal groups from the group space whose users are permitted to access the electronic application is determined. The set of optimal groups is determined by ordering the groups in the group space based on a total quantity of users in a group, a quantity of overprivileged users in the group (e.g., users who do not require access to the electronic application such as users who have more permissions or access rights to the electronic application than are necessary for current roles or responsibilities associated with the users), and a quantity of underprivileged users in the user space (e.g., users who require access to the electronic application but who are not in the group). A first group in the ordering is assigned to the set of optimal groups. The first group is removed from the group space and the users in the first group are removed from the user space. The one or more remaining groups are iteratively re-ordered, assigned, and removed from the group space, and their users are removed from the user space, after assignment and removal of the first group. The re-ordering, assigning, and removing of the one or more remaining groups from the group space proceeds iteratively until no remaining group breaches an access threshold or the user space is empty.

In some embodiments, at processing block 306, users who remain in the user space after the iterative re-ordering, assigning, and removing; and who require access to the electronic application; are grouped into a group in the set of optimal groups, or into a new group in the set of optimal groups. In some embodiments, the users who remain in the user space after the iteratively re-ordering, assigning, and removing; and who require access to the electronic application; are listed on a list.

As shown in FIG. 3, flow 300 comprises outputting 308 and 310 one or more of: the set of optimal groups; the listing; and indications of risks associated with specific users or groups in the set of optimal groups. The risks are determined (as described herein) based on an overprivileged rate for the set of optimal groups or other information. In some embodiments, outputs 308 and 310 may include one or both of a percentage of users in the user space included in a group that is part of the set of optimal groups, and an overprivileged rate for the set of optimal groups, or other statistics. This information may be used by an information technology administrator, for example, to gage risks associated with unnecessarily providing access to an electronic application to users who do not need that access, balanced with ensuring that those who do need access have it, or for other purposes. The outputting 308 and 310 may be configured to guide generation of one or more new security groups for the electronic application, for example.

As shown in FIG. 3, the application ID can be used to discover 312 a user space comprising the users associated with the electronic application. These users may comprise one or more of users in one or more preexisting administrative registers associated with the electronic application; active users who have used the electronic application with a recent period of time (e.g., 90 days as in the example shown in FIG. 3); users whose organizational roles and responsibilities are associated with the electronic application; or other users.

In some embodiments, grouping is based on user data that indicates user membership in one or more preexisting administrative registers 314. The one or more preexisting administrative registers comprise group membership information 316 and may indicate electronic application access rights for the users, for example.

In some embodiments, ordering the groups in the group space comprises scoring the groups in the group space based on the total quantity of users in a group, the quantity of overprivileged users in the group multiplied by a penalty for the overprivileged users, the quantity of underprivileged users in the user space multiplied by a penalty for the underprivileged users, or other factors.

In some embodiments, one or both of the penalty for the overprivileged users and the penalty for the underprivileged users are determined 318 based on a required level of security associated with the electronic application, or other information. For example, the penalty for the overprivileged users may be increased responsive to the electronic application requiring relatively high security compared to other electronic applications. In some embodiments, the penalty for the overprivileged users and the penalty for the underprivileged users is determined by predefining a range of possible values for the penalty for the overprivileged users and the penalty for the underprivileged users. The groups in the group space are scored based on different combinations of the possible values for the penalty for the overprivileged users and the penalty for the underprivileged users. For the combinations of the possible values for the penalty for the overprivileged users and the penalty for the underprivileged users, optimization module 118 evaluates the groups that would be in the set of optimal groups based on a total quantity of users from the user space in the groups that would be in the set of optimal groups, the quantity of overprivileged users in the groups that would be in the set of optimal groups, and the quantity of underprivileged users not in the groups that would be in the set of optimal groups. The penalty for the overprivileged users and the penalty for the underprivileged users is determined based on this evaluation, such that a desired balance between the total quantity of users from the user space in the groups that would be in the set of optimal groups (e.g., the coverage) and overprivileged user minimization is achieved. In some embodiments, the penalty for the overprivileged users and the penalty for the underprivileged users, a coverage requirement indicating a total quantity or percentage of users who should have access to the electronic application who are in a group in the set of optimal groups, or other requirements may be provided as input to flow 300.

Phrased another way, flow 300 may receive an application ID as input, along with the penalty for the overprivileged users and the penalty for the underprivileged users, and a minimum coverage requirement. Flow 300 (executed by system 100 shown in FIG. 1A) causes the users who have used the electronic application in the past 90 (in this example) days (e.g., active users), which comprises the user space, to be discovered and grouped into groups that include at least one of these users, which is called the group space. Flow 300 then iterates through the group space, and orders a group based on how well it covers the user space (e.g., based on the number of active users in a group) and how much it overprivileges certain users (e.g., the number of inactive users in the group, or users who do not require access but retain access anyway). A first group in the order is assigned to a set of optimal groups whose users are permitted to access the electronic application, and the user space and the group space are updated accordingly by removing the users and group assigned to the set of optimal groups. Flow 300 repeats this process until no more groups breach an access threshold, or the user space is empty. Flow 300 returns (or outputs) the set of optimal groups and the remaining users that need direct access or a new group assignment, among other output information.

Returning to FIG. 1A, for new electronic applications, for which there are no users yet associated with the electronic application (i.e., at input 304 in flow 300), grouping module 116 may be configured to initially associate a broad group of users with the electronic application, such as all personnel in an organization. Then after a period of time, grouping module 116 and optimization module 118 may determine the set of optimal groups as described herein (e.g., based on active user data, changing roles and responsibilities within the organization, etc., or other data collected during that period of time).

In some embodiments, grouping module 116 may receive a list of users who require access to the new electronic application. In these embodiments, grouping module 116 may treat this list of users as the user space, group the users into groups, and optimization module 118 may determine the set of optimal groups. The modules would work as described above, treating the user list as the user space, grouping the users, and ordering the groups based on how well they cover the user space, and how much a group overprivileges certain users (e.g., using the over and under privilege penalties adjusted to control the trade-off between coverage and overprivilege).

In some embodiments, optimization module 118 may be unable to determine a set of optimal groups for a given electronic application. There may be several reasons why optimization module 118 might be unable to determine a set of optimal groups for a given electronic application. For example, optimization module 118 may lack enough historical usage data or relevant information (e.g., insufficient data) to accurately determine optimal groups. The requirements for access privileges might be too complex or conflicting, making it difficult to form groups that satisfy all conditions. The electronic application might be in a highly dynamic environment where user roles and access needs change frequently, making it challenging to establish stable groups. Stringent security requirements might limit the ability to form groups that balance overprivileged and underprivileged users effectively. The optimization algorithm itself might have limitations or might not be well-suited to handle the specific characteristics of the electronic application. Other examples are contemplated. In these embodiments, output module 120 is configured to output the set of users in the user space, with the output set of users assumed to require direct granting of access privileges to the electronic application.

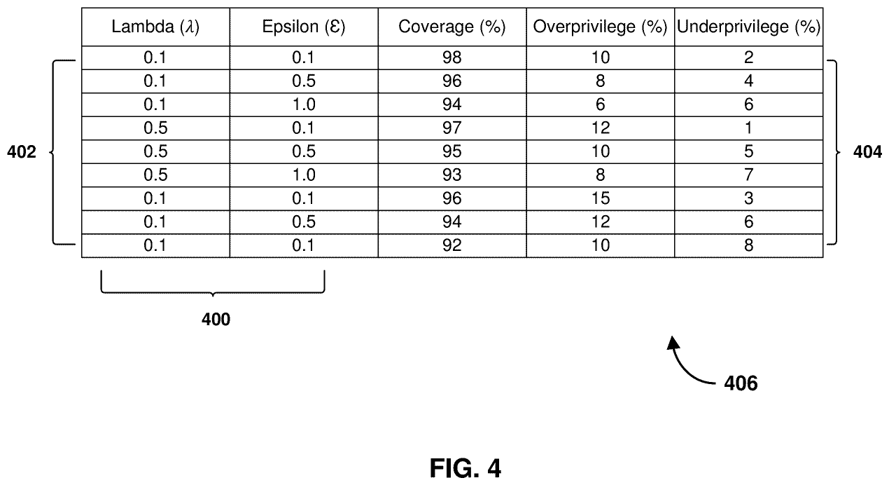

FIG. 4 illustrates a practical example of over and under privilege penalty determination. As described above, one or both of the penalty for the overprivileged users and the penalty for the underprivileged users are determined based on a required level of security associated with an electronic application, or other information. In some embodiments, the penalty for the overprivileged users and the penalty for the underprivileged users is determined by predefining a range of possible values for the penalty for the overprivileged users and the penalty for the underprivileged users. The groups in the group space are scored based on different combinations of the possible values for the penalty for the overprivileged users and the penalty for the underprivileged users. For the combinations of the possible values for the penalty for the overprivileged users and the penalty for the underprivileged users, the groups that would be in the set of optimal groups are evaluated based on a total quantity of users from the user space in the groups that would be in the set of optimal groups, the quantity of overprivileged users in the groups that would be in the set of optimal groups, and the quantity of underprivileged users not in the groups that would be in the set of optimal groups. The penalty for the overprivileged users and the penalty for the underprivileged users is determined based on this evaluation, such that a desired balance between the total quantity of users from the user space in the groups that would be in the set of optimal groups (e.g., the coverage) and overprivileged user minimization is achieved. These operations are described with example numbers below.

The penalty for the overprivileged users and the penalty for the underprivileged users are sometimes called hyperparameters. In this example, the penalty for overprivileged users (a first hyperparameter) is represented by lambda (λ)—which controls the penalty for users in a group who do not need access to the application (e.g., overprivilege as described above). The penalty for underprivileged users (a second hyperparameter) is represented by epsilon (ε)—which controls the penalty for users who need access to the application but are not in the group (e.g., underprivilege as described above).

The penalty or hyperparameter determination process is configured to find optimal values for lambda (λ) and epsilon (ε), which control the penalties for overprivilege and underprivilege, respectively. This process helps to fine-tune the group ordering operation to achieve the best balance between coverage and minimizing unnecessary access to an electronic application. These penalties can affect the quality and quantity of the groups assigned to the set of optimal groups, and may need to be adjusted for different electronic applications (e.g., electronic applications that require a relatively higher security level compared to other electronic applications) or other scenarios.

The penalty or hyperparameter determination process is designed to optimize the values of lambda (λ) and epsilon (ε). To test different values 400 of these parameters in various combinations 402, the determination process runs the group ordering operations iteratively for combinations 402, and records the resulting coverage, overprivilege, and underprivilege rates (e.g., performance metrics 404). This evaluation facilitates generation of a summary table 406, listing performance metrics 404 for combinations 402. By analyzing the performance metrics 404 in table 406, the optimal penalty (e.g., lambda and epsilon) values are determined based on the desired balance between maximizing coverage of active users and minimizing unnecessary access. Implementing these optimal values ensures the group ordering operations are performed consistently and efficiently, meeting specific security and operational requirements, among other advantages.

In some embodiments, lambda (λ) and epsilon (ε) may have a predefined starting range. The predefined starting ranges for lambda (λ) and epsilon (ε) values may be determined from empirical analysis and historical data, or other information. These values may be chosen based on prior experience and experimentation with similar systems or applications. For example, values like 0.1, 0.5, and 1 are often selected because they provide a good balance between coverage and privilege minimization in many scenarios. These values are not arbitrary; they are informed by past performance metrics and the need to fine-tune the algorithm to achieve optimal results. Moreover, this range may be determined automatically by the system through a process known as hyperparameter optimization. System 100 may be configured to iterate over various combinations of λ and ε values within a predefined range and evaluate the performance metrics for a combination. By analyzing the trade-offs between coverage, overprivilege, and underprivilege rates, system 100 can identify the optimal values that provide the desired balance. This automated approach ensures that the parameters are tailored to the specific requirements and security needs of the electronic application, leading to more accurate and efficient group assignments.

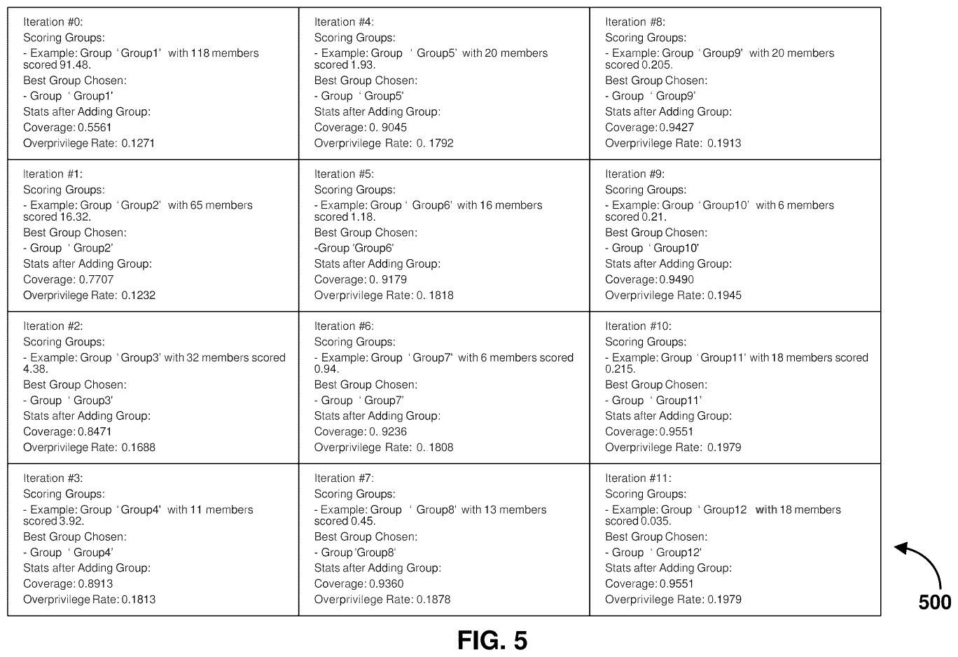

Example ranges might be λ={0.1, 0.5, 1} and ε={0.1, 0.5, 1}. The determination process may be initialized by iterating over all combinations of λ and ε values within the predefined ranges (see combinations 402 in table 406). For a combination of λ and ε, the group ordering operations are performed (see more details about group ordering based on scores in FIG. 5 and the paragraphs below). Performance metrics 404 are determined for individual groups using the corresponding λ and ε values (see the various rows in table 406). For individual combinations 402 of the possible values 400 for the penalty for the overprivileged users and the penalty for the underprivileged users, the groups that would be in the set of optimal groups are evaluated based on a total quantity of users from the user space in the groups that would be in the set of optimal groups (coverage % in this example), the quantity of overprivileged users in the groups that would be in the set of optimal groups (overprivilege % in this example), and the quantity of underprivileged users not in the groups that would be in the set of optimal groups (underprivilege % in this example). Optimal penalty values are identified by evaluating trade-offs between coverage and privilege rates. The combination of λ and ε that provides a desired balance between coverage and privilege minimization are chose and used by system 100 (FIG. 1A) as described herein.

Note that the optimal penalty values depend on the specific security requirements and tolerance for overprivilege and underprivilege for a given electronic application. Relatively high security electronic applications may require stricter lambda and epsilon parameters, resulting in less overprivilege, for example. This determination process ensures that the most appropriate balance between coverage, overprivilege, and underprivilege is achieved for the given electronic application, allowing for more secure and efficient group assignments, better resource management and easier administrative control, among other advantages compared to such assignments in past systems.

FIG. 5 illustrates a practical example of group ordering and assignment to a set of optimal groups. In this example, groups are ordered based on scores. Scoring is one possible example of ranking, prioritizing, or otherwise ordering the groups. The scoring evaluates how well a user group fits an electronic application's access requirements based on three main criteria: coverage, overprivilege, and under-privilege. As described above, in some embodiments, optimization module 118 (FIG. 1A) is configured such that ordering the groups in the group space comprises scoring the groups in the group space based on the total quantity of users in a group (e.g., coverage), the quantity of overprivileged users in the group multiplied by the penalty for the overprivileged users (e.g., overprivilege), and the quantity of underprivileged users in the user space multiplied by the penalty for the underprivileged users (underprivilege).

For this example, it is useful to define, or remind the reader, of various parameters, including active users (A)—the number of users from the group who have accessed the application in the past 90 (in this example) days; group members (G)—the total number of users in a group; overprivileged users (O)—users in the group who have not accessed, or do not need to access, an electronic application but would gain access if the group is assigned to the set of optimal groups; underprivileged users (U)—users who have accessed, or who need to access the electronic application, but who are not included in the group; penalty lambda (λ)—the penalty for overprivileged users; and penalty epsilon (ε)—the penalty for underprivileged users.

Groups in the group space (see FIG. 2) may be scored, and ordered based on the score. The group with the highest score is assigned to the set of optimal groups whose users are permitted to access the electronic application. The score(S) for a group may be determined using the formula: S=A−(lambda * O)−(epsilon * U). This formula takes into account both overprivilege and underprivilege by applying the respective penalties.

Described in terms of a detailed set of steps for scoring a group, Step 1 may comprise counting active users (A)—determining the number of users in the group who have accessed the application. Step 2 may comprise counting overprivileged users (O)—identifying the users in the group who have not accessed, or do not need to access, the electronic application, but are members of the group. Step 3 may comprise count underprivileged users (U)—identifying the users who have accessed, or need to access, the electronic application, but are not part of this group. Step 4 may comprise applying the penalties (λ and ε)—multiplying the number of overprivileged users by lambda and the number of underprivileged users by epsilon. Step 5 may comprise determining the score(S)—subtracting the penalties from the number of active users (A).

An example group score determination may occur as follows. Suppose there is a group with: total group members (G)=150; active users in the group (A)=118; overprivileged users (O)=32; underprivileged users (U)=12; lambda (λ)=0.5, and epsilon (ε)=1. The penalty for overprivileged users is applied: O * λ=32 * 0.5=16. The penalty for underprivileged users is applied: U * ε=12 * 1=12. The score is then determined as S=A−(O * λ)−(U * ε)=118−16−12=90.

In this example, a higher score indicates that the group covers many active users with minimal overprivilege and underprivilege. A lower or negative score indicates that the group has significant overprivilege or underprivilege relative to its coverage of active users. In some embodiments, the access threshold described above may comprise a score of zero, such that groups with positive scores are above the access threshold, and groups with negative scores are below the access threshold, for the purpose of determining whether to continue iterating through the groups in the group space (as described above related to FIG. 1A and FIG. 2).

When determining the set of optimal groups from the group space, in an iteration, the group with the highest positive score may be assigned (e.g., by optimization module 118 shown in FIG. 1A) to the set of optimal groups. The assigned group's covered users are removed from further consideration (e.g., the users are removed from the user space and the group is removed from the group space as described above), and the remaining groups may be iteratively re-scored (e.g., re-ordered), assigned to the set of optimal groups as appropriate, and removed. This ensures iterative improvement in coverage with controls for overprivileged and under-privileged users. By managing both overprivileged users and underprivileged uses effectively using the lambda (λ) and epsilon (ε) penalty parameters, system 100 (FIG. 1A) provides a balanced and optimized group assignment for enhancing security and administrative efficiency.

FIG. 5 provides an example of iterative group scoring, and group assignment to the set of optimal groups, for a user space with 157 users, an initial group space with 2629 groups, and a filtered (e.g., as described above) group space size of 1148 groups (note these are just example numbers used for demonstration purposes). FIG. 5 illustrates a table 500 showing group scoring for iterations 0-11 (with the iterations progressing top to bottom and left to right in table 500). In an iteration, a group with the highest score is assigned to (or chosen for) the set of optimal groups. Coverage and overprivilege rates are shown for an iteration after adding the highest scoring group to the set of optimal groups. The calculation is performed on the group that was assigned to the set of optimal groups. Once the group is assigned, the scoring is run for the remaining groups in the group space, and this process is done iteratively. The iterative process of scoring, assigning, and removing groups continues until no more groups with positive scores remain in the group space, or the user space is empty (e.g., as described above). The iterative process concludes with a set of optimal groups that cover a significant percentage of active users. The coverage, overprivilege rate, or other statistics (as described above) may be determined for this final set of groups. In this example, the process concludes after 11 iterations. The coverage for the assigned groups is 95.51%, and the overprivilege rate is 19.79%. In this example, the set of optimal groups comprises Groups 1-12.

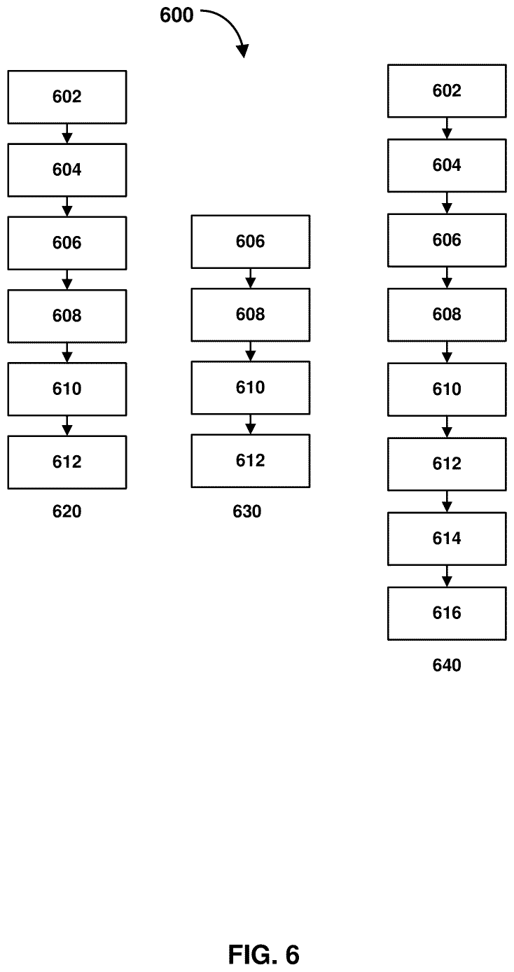

FIG. 6 illustrates different example embodiments 620, 630, and 640 of a method 600 for limiting access privileges to provide secure group-based access to an electronic application. Embodiments 620, 630, and 640 of method 600 are performed with system 100 (FIG. 1A-FIG. 1D) or other components discussed above. Embodiments 620, 630, or 640 may correspond to one or more of the pathways through the flow shown in FIG. 3, for example.

Embodiment 620 of method 600 begins with operation 602, comprising discovering a user space comprising users associated with the electronic application. Embodiment 620 continues with operation 604, comprising grouping the users into groups to form a group space, with individual groups in the group space including at least one user from the user space. Operation 606 comprises determining a set of optimal groups from the group space whose users are permitted to access the electronic application by ordering the groups in the group space. The ordering is based on a total quantity of users in a group, a quantity of overprivileged users in the group (with the overprivileged users comprising users who do not require access to the electronic application), and a quantity of underprivileged users in the user space (with the underprivileged users comprising users who require access to the electronic application but who are not in the group). Operation 608 comprises assigning a first group in the ordering to the set of optimal groups; and operation 610 comprises removing the first group from the group space and the users in the first group from the user space. Operation 612 comprises iteratively re-ordering, assigning, and removing one or more remaining groups from the group space and their users from the user space after assignment and removal of the first group (e.g., all as described above).

Embodiment 630 of method 600 begins with operation 606, again comprising determining a set of optimal groups from the group space whose users are permitted to access the electronic application by ordering the groups in the group space. Embodiment 630 assumes that the discovering and grouping operations 602 and 604 are already performed. Embodiment 630 continues with operation 608 (assigning a first group in the ordering to the set of optimal groups) and operation 610 (removing the first group from the group space and the users in the first group from the user space). Embodiment 630 again concludes with operation 612 (iteratively re-ordering, assigning, and removing one or more remaining groups from the group space and their users from the user space after assignment and removal of the first group (e.g., all as described above).

Embodiment 640 of method 600 begins with operation 602 (discovering a user space comprising users associated with the electronic application), and continues with operation 604 (grouping the users into groups to form a group space, with individual groups in the group space including at least one user from the user space). Embodiment 640 includes operation 605, comprising filtering the groups in the group space based on predefined upper and lower group size thresholds prior to the ordering. Filtering the groups based on the predefined upper and lower size thresholds includes removing groups that exceed maximum upper size or fall below minimum lower size thresholds. Embodiment 640 continues with operation 606 (determining a set of optimal groups from the group space whose users are permitted to access the electronic application by ordering the groups in the group space), operation 608 (assigning a first group in the ordering to the set of optimal groups), operation 610 (removing the first group from the group space and the users in the first group from the user space), and operation 612 (iteratively re-ordering, assigning, and removing one or more remaining groups from the group space and their users from the user space after assignment and removal of the first group). Embodiment 640 also includes operation 614, comprising grouping users who remain in the user space after the iteratively re-ordering, assigning, and removing; and who require access to the electronic application; into a group in the set of optimal groups, or into a new group in the set of optimal groups; or listing the users who remain in the user space after the iteratively re-ordering, assigning, and removing; and who require access to the electronic application. Embodiment 640 concludes with operation 616, comprising outputting one or more of: the set of optimal groups; the listing; and indications of risks associated with specific users or groups in the set of optimal groups. The risks are determined based on an overprivileged rate for the set of optimal groups (as described above). In some embodiments, operation 616 comprises determining and outputting one or both of: a percentage of users in the user space included in a group that is part of the set of optimal groups; and an overprivileged rate for the set of optimal groups. The outputting may be configured to guide generation of one or more new security groups for the electronic application, for example.

Embodiments 620, 630, and 640 of method 600 may include additional operations that are not described, or not include one or more of the operations described below. The operations of embodiments 620, 630, and 640 of method 600 may be performed in any order that facilitates limiting access privileges to provide secure group-based access to an electronic application, as described herein. Even though these are shown as separate embodiments, operations from one embodiment may be combined with another. In addition, embodiments 620, 630, and 640 are not the only three possible embodiments of method 600. Other variations are contemplated.

Returning to FIG. 1A, system 100 can have many different forms, with or without some or all of the components shown in FIG. 1A, and still be configured to function as described. For example, FIG. 1B, FIG. 1C, and FIG. 1D illustrate examples of alternative potential embodiments of system 100. FIG. 1B illustrates system 100 without API server 126, web server 128, cache server 132, mobile user devices 134 and 136, or desktop user device 138 (e.g., which in this example are their own standalone devices, apart from system 100). FIG. 1C illustrates system 100 with processor 114, instructions 160 (including the different modules 116-120), memory 130 (which may or may not be included in the same computing structure as processor 114), and data sources 148. In this example, the data sources are their own separate entities, not necessarily being related to each other. FIG. 1D illustrates system 100 with processor 114, instructions 160 (without being separately divided into the different modules 116-120), memory 130 (which again may or may not be included in the same computing structure as processor 114), and data sources 148. Other embodiments with different arrangements of components are contemplated.

In FIGS. 1A-1D , the different components of system 100 are illustrated communicating via network 150. This is not intended to be limiting. As described herein, different components of system 100 communicate via network 150 (as shown), via wired connections, or via other wired or wireless connections. The illustrated components communicate directly with each other (e.g., via network 150 or a wired connection), or indirectly via other components of system 100.

It should be noted that in some embodiments, computing engine 112 is configured such that in the above mentioned operations of processor 114, and input from users or sources of information inside or outside system 100, are processed by processor 114 through a variety of formats, including clicks, touches, uploads, downloads, etc.. The illustrated components (e.g., processor 114, API server 126, web server 128, memory 130, and cache server 132) of computing engine 112 are depicted as discrete functional blocks, but embodiments are not limited to systems in which the functionality described herein is organized as illustrated by FIG. 1A. In some embodiments, the functionality provided by the components of computing engine 112 is provided by software or hardware modules that are differently organized than is presently depicted, for example such software or hardware is intermingled, broken up, distributed (e.g., within a data center or geographically), or otherwise differently organized. In some embodiments, the functionality described is provided by one or more processors of one or more computers executing code stored on a tangible, non-transitory, machine readable medium.

It should be appreciated that although modules 116-120 are illustrated in FIG. 1A (and 1B and 1C) as being co-located, one or more of modules 116, 118, or 120 may be located remotely from the other modules. The description of the functionality provided by the different modules 116, 118, or 120 described herein is for illustrative purposes, and is not intended to be limiting, as any of the modules 116, 118, or 120 may provide more or less functionality than is described, which is not to imply that other descriptions are limiting. For example, one or more of modules 116, 118, or 120 may be eliminated, and some or all of its functionality may be provided by others of the modules 116, 118, or 120, again which is not to imply that other descriptions are limiting. As another example, processor 114 may be configured to control one or more additional modules that perform some or all of the functionality attributed to one of the modules 116, 118, or 120.

Modules 116-120 are program instructions that are executable by a processor 114 to implement one or more embodiments of the present techniques. In some embodiments, program instructions include a computer program (which in certain forms is known as a program, software, software application, script, or code). A computer program is written in a programming language, including compiled or interpreted languages, or declarative or procedural languages. In some embodiments, a computer program includes a unit suitable for use in a computing environment, including as a stand-alone program, a module, a component, or a subroutine. In some embodiments, a computer program corresponds to a file in a file system. A program is stored in a portion of a file that holds other programs or data (e.g., one or more scripts stored in a markup language document), in a single file dedicated to the program in question, or in multiple coordinated files (e.g., files that store one or more modules, sub programs, or portions of code). In some embodiments, a computer program is deployed to be executed on one or more computer processors located locally at one site or distributed across multiple remote sites and interconnected by a communication network, for example.

Cache server 132 expedites access to relevant data by storing likely relevant data in relatively high-speed memory, for example, in random-access memory or a solid-state drive (e.g., formed by at least a portion of memory 130). Web server 128 serves webpages having graphical user interfaces that display one or more views that facilitate receiving entry or selection of input from a user (e.g., including a query or command that system 100 perform a certain task, providing context, etc.), or other views. API server 126 serves data to various applications that process data related to user requested tasks, or other data. The operation of these components (API server 126, web server 128, and memory 130) is coordinated by processor 114, which bidirectionally communicates with these components or directs the components to communicate with one another. Communication occurs by transmitting data between separate computing devices (e.g., via transmission control protocol/internet protocol (TCP/IP) communication over a network), by transmitting data between separate applications or processes on one computing device; or by passing values to and from functions, modules, or objects within an application or process, e.g., by reference or by value.

API server 126 is configured to communicate user text commands or other information via a protocol, such as a representational-state-transfer (REST)-based API protocol over hypertext transfer protocol (HTTP) or other protocols. API requests identify which output data is to be determined, displayed, linked, modified, added, or retrieved by specifying criteria for identifying tasks, such as queries for retrieving or processing information about a particular subject (e.g., an optimal list of groups for a certain electronic application). In some embodiments, API server 126 communicates with native application 140 of the mobile user device 134, native application 145 of desktop user device 138, or other components of system 100.

Web server 128 is configured to display, link, modify, add, or retrieve portions or all of an output, or other information encoded in a webpage (e.g., a collection of resources to be rendered by the browser and associated plug-ins, including execution of scripts, such as JavaScript™, invoked by the webpage). In some embodiments, the graphical user interface presented by the webpage includes inputs by which the user enters or selects data, such as clickable or touchable display regions or display regions for text input. Such inputs prompt the browser to request additional data from web server 128 or transmit data to web server 128, and web server 128 responds to such requests by obtaining the requested data and returning it to the user device or acting upon the transmitted data (e.g., storing posted data or executing posted commands). In some embodiments, the requests are for a new webpage or for data upon which client-side scripts will base changes in the webpage, such as XMLHttpRequest requests for data in a serialized format, e.g., JavaScript™ object notation (JSON) or extensible markup language (XML). Web server 128 communicates with web browsers, such as web browser 142 or 144 executed by user devices 136 or 138. In some embodiments, the webpage is modified by web server 128 based on the type of user device, e.g., with a mobile webpage having fewer and smaller images and a narrower width being presented to the mobile user device 136, and a larger, more content rich webpage being presented to the desktop user device 138. In some embodiments, an identifier of the type of user device, either mobile or non-mobile, for example, is encoded in the request for the webpage by the web browser (e.g., as a user agent type in an HTTP header associated with a GET request), and web server 128 selects the appropriate interface based on this embedded identifier, thereby providing an interface appropriately configured for the specific user device in use.

Web browsers 142 and 144 are configured to receive a website from computing engine 112 having data related to instructions (for example, instructions expressed in JavaScript™) that when executed by the browser (which is executed by the processor) cause mobile user devices 134 or 136, or desktop user device 138, to communicate with computing engine 112 and facilitate user interaction with data from computing engine 112. Native applications 140 and 145, and web browsers 142 and 144, upon rendering a webpage or a graphical user interface from computing engine 112, may generally be referred to as client applications of computing engine 112, which in some embodiments may be referred to as a server. Embodiments, however, are not limited to client/server architectures, and computing engine 112, as illustrated, may include a variety of components other than those functioning primarily as a server. Three user devices are shown, but embodiments are expected to interface with substantially more, with more than 100 concurrent sessions and serving more than 1 million users distributed over a relatively large geographic area, such as a state, the entire United States, or multiple countries across the world.

Though not illustrated in FIG. 1A (or 1B, 1C, or 1D), computing engine 112, in some embodiments, includes multiple processors 114, an input/output I/O device interface, and a network interface via an input/output (I/O) interface. In some embodiments, multiple processors are employed to provide for parallel or sequential execution of one or more portions of the techniques described herein. The I/O device interface provides an interface for connection of one or more I/O devices to computing engine 112. I/O devices include devices that receive input (e.g., from a user) or output information (e.g., to a user). I/O devices include, for example, graphical user interfaces presented on displays (e.g., a touchscreen or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices are connected to computing engine through a wired or wireless connection. I/O devices are connected to computing engine 112 from a remote location. I/O devices located on a remote computer system, for example, are connected to computing engine 112 via network 150 and the network interface.

The network interface includes a network adapter that provides for connection of computing engine 112 to network 150. The network interface facilitates data exchange between computing engine 112 and other devices connected to network 150. The network interface supports wired or wireless communication. In some embodiments, network 150 includes an electronic communication network, such as the Internet, a local area network (LAN), a wide area network (WAN), a cellular communications network, or the like.

The I/O interface is configured to coordinate I/O traffic between processors, memory 130, the network interface, I/O devices, or other peripheral devices. The I/O interface performs protocol, timing, or other data transformations to convert data signals from one component (e.g., memory 130) into a format suitable for use by another component (e.g., processor(s) 114). In some embodiments, the I/O interface includes support for devices attached through various types of peripheral buses, such as a variant of the Peripheral Component Interconnect (PCI) bus standard or the Universal Serial Bus (USB or USB-C) standard.

Embodiments of the techniques described herein may be implemented using a single instance of computing engine 112 or multiple computer systems configured to host different portions or instances of embodiments. Multiple computer systems may provide for parallel or sequential processing/execution of one or more portions of the techniques described herein.

While various items are illustrated as being stored in memory, these items or portions of them may be transferred between memory and other storage devices for purposes of memory management and data integrity. Alternatively, in other embodiments some or all of the software components executes in memory on another device and communicates with the illustrated computer system via inter-computer communication. In some embodiments, some or all of the system components or data structures are stored (e.g., as instructions or structured data) on a computer-accessible medium or a portable article to be read by an appropriate drive, various examples of which are described above. In some embodiments, instructions stored on a computer-accessible medium separate from computing engine 112 are transmitted to computing engine 112 via transmission media or signals such as electrical, electromagnetic, or digital signals, conveyed via a communication medium such as a network or a wireless link. Various embodiments include receiving, sending, or storing instructions or data implemented in accordance with the foregoing description upon a computer-accessible medium. Accordingly, the present techniques may be practiced with other computer system configurations.

To mitigate the problems described herein, the inventors had to both invent solutions and, in some cases just as importantly, recognize problems overlooked (or not yet foreseen) by others for limiting access privileges to provide secure group-based access to an electronic application. The inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described.

In block diagrams, illustrated components are depicted as discrete functional blocks, but embodiments are not limited to systems in which the functionality described herein is organized as illustrated. The functionality provided by the components may be provided by software or hardware modules that are differently organized than is presently depicted, for example such software or hardware may be intermingled, conjoined, replicated, broken up, distributed (e.g., within a data center or geographically), or otherwise differently organized. The functionality described may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with individual computing devices having different subsets of the instructions, an implementation consistent with usage of the singular term “medium.” In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several embodiments. Rather than separating those embodiments into multiple isolated patent applications, applicants have grouped these embodiments into a single document because their related subject matter lends itself to economies in the application process. But the distinct advantages and aspects of these embodiments should not be conflated. In some cases, embodiments address all of the deficiencies noted herein, but it should be understood that the embodiments are independently useful, and some embodiments address only a subset of such problems or offer other, unmentioned benefits that will be apparent to those of skill in the art reviewing the present disclosure. Due to cost constraints, some disclosed embodiments are not presently claimed and may be claimed in later filings, such as continuation applications or by amending the present claims. Similarly, due to space constraints, neither the Abstract nor the Summary sections of the present document should be taken as containing a comprehensive listing of all such embodiments or all aspects of such embodiments.

It should be understood that the description and the drawings are not intended to limit an embodiment to the particular form disclosed, but to the contrary, the intention is to cover all modifications, equivalents, and alternatives falling within the spirit and scope of the present embodiments as defined by the appended claims. Further modifications and alternative embodiments will be apparent to those skilled in the art in view of this description. Accordingly, this description and the drawings are to be construed as illustrative only and are for the purpose of teaching those skilled in the art the general manner of carrying out the embodiments. It is to be understood that the forms of the embodiments shown and described herein are to be taken as examples of embodiments. Elements and materials may be substituted for those illustrated and described herein, parts and processes may be reversed or omitted, and certain features may be utilized independently, all as would be apparent to one skilled in the art after having the benefit of this description. Changes may be made in the elements described without departing from the spirit and scope of the embodiments as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include,” “including,” and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., all processors performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in a category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The present techniques will be better understood with reference to the following enumerated embodiments:
1. A method for limiting access privileges to provide secure group-based access to an electronic application, the method comprising: discovering a user space comprising users associated with the electronic application; grouping the users into groups to form a group space, with the groups in the group space including the users from the user space; and determining a set of optimal groups from the group space, the set of optimal groups comprising the users from the user space permitted to access the electronic application, the set of optimal groups determined by: ordering the groups in the group space based on: a total quantity of the users in a group, a quantity of overprivileged users in the group, wherein the overprivileged users do not require access to the electronic application, and a quantity of underprivileged users in the user space, wherein the underprivileged users require access to the electronic application but are not in the group; assigning a first group in the ordering to the set of optimal groups; removing the first group from the group space and the users in the first group from the user space; and iteratively re-ordering, assigning, and removing one or more remaining groups from the group space and the users in the one or more remaining groups from the user space after assignment and removal of the first group.
2. The method of embodiment 1, wherein the re-ordering, assigning, and removing the one or more remaining groups from the group space proceeds iteratively until: no remaining group breaches an access threshold, wherein the access threshold is determined based on the total quantity of users in the group, the quantity of overprivileged users, and the quantity of underprivileged users; or the user space is empty.
3. The method of any of the previous embodiments, wherein one or both of the ordering and the access threshold are further determined based on a penalty for the overprivileged users and a penalty for the underprivileged users.
4. The method of any of the previous embodiments, further comprising adjusting one or both of the penalty for the overprivileged users and the penalty for the underprivileged users based on a required level of security associated with the electronic application.
5. The method of any of the previous embodiments, wherein the penalty for the overprivileged users is increased responsive to the electronic application requiring relatively high security compared to other electronic applications.
6. The method of any of the previous embodiments, further comprising: grouping the users who remain in the user space after the iteratively re-ordering, assigning, and removing; and who require access to the electronic application; into a group in the set of optimal groups, or into a new group in the set of optimal groups; or listing the users who remain in the user space after the iteratively re-ordering, assigning, and removing; and who require access to the electronic application.
7. The method of any of the previous embodiments, further comprising outputting one or more of: the set of optimal groups; the listing; and indications of risks associated with specific users or groups in the set of optimal groups, wherein the risks are determined based on an overprivileged rate for the set of optimal groups.
8. The method of any of the previous embodiments, wherein the outputting is configured to guide generation of one or more new security groups for the electronic application.
9. The method of any of the previous embodiments, wherein the overprivileged users further comprise the users who have more permissions or access rights to the electronic application than are necessary for current roles or responsibilities associated with the users.
10. The method of any of the previous embodiments, wherein determining the set of optimal groups further comprises filtering the groups in the group space based on predefined upper and lower group size thresholds prior to the ordering.
11. The method of any of the previous embodiments, wherein filtering the groups based on the predefined upper and lower size thresholds includes removing groups that exceed maximum upper size or fall below minimum lower size thresholds.
12. The method of any of the previous embodiments, wherein the upper and lower size thresholds are determined based on historical usage data for the electronic application.
13. The method of any of the previous embodiments, wherein the grouping is based on user data that indicates user membership in one or more preexisting administrative registers.
14. The method of any of the previous embodiments, wherein the one or more preexisting administrative registers comprise group membership information and indicate electronic application access rights for the users.
15. The method of any of the previous embodiments, wherein the users associated with the electronic application comprise one or more of the users in one or more preexisting administrative registers associated with the electronic application; active users who have used the electronic application with a recent period of time; and the users whose organizational roles and responsibilities are associated with the electronic application.
16. The method of any of the previous embodiments, further comprising: discovering changes in one or more of: the one or more preexisting administrative registers, the active users, and the user roles and responsibilities; and re-grouping the users based on the changes.
17. The method of any of the previous embodiments, further comprising discovering one or more additional user spaces associated with one or more additional electronic applications in a directory; grouping additional users associated with the one or more additional electronic applications into additional groups to form one or more additional group spaces; and determining one or more additional sets of optimal groups comprising the additional users permitted to access the one or more additional electronic applications; for limiting access privileges to provide secure group-based access to the one or more additional electronic applications.
18. The method of any of the previous embodiments, further comprising determining and outputting one or both of: a percentage of the users in the user space included in a group that is part of the set of optimal groups; and an overprivileged rate for the set of optimal groups.
19. The method of any of the previous embodiments, wherein ordering the groups in the group space comprises scoring the groups in the group space based on the total quantity of the users in a group, the quantity of overprivileged users in the group multiplied by a penalty for the overprivileged users, and the quantity of underprivileged users in the user space multiplied by a penalty for the underprivileged users.
20. The method of any of the previous embodiments, further comprising determining the penalty for the overprivileged users and the penalty for the underprivileged users by: predefining a range of possible values for the penalty for the overprivileged users and the penalty for the underprivileged users; scoring the groups in the group space based on different combinations of the possible values for the penalty for the overprivileged users and the penalty for the underprivileged users; for combinations of the possible values for the penalty for the overprivileged users and the penalty for the underprivileged users, evaluating the groups that would be in the set of optimal groups based on a total quantity of the users from the user space in the groups that would be in the set of optimal groups, the quantity of overprivileged users in the groups that would be in the set of optimal groups, and the quantity of underprivileged users not in the groups that would be in the set of optimal groups; and determining the penalty for the overprivileged users and the penalty for the underprivileged users based on the evaluating such that a desired balance between the total quantity of the users from the user space in the groups that would be in the set of optimal groups and overprivileged user minimization is achieved.
21. A system, comprising: a processor; and memory storing instructions that, when executed by the processor, cause the system to: determine a set of optimal groups from a group space, the set of optimal groups comprising users from a user space permitted to access an electronic application, an electronic file, or electronic data, the set of optimal groups determined by ordering the groups in the group space based on: a total quantity of the users in a group, a quantity of overprivileged users in the group, wherein the overprivileged users do not require access to the electronic application, the electronic file, or the electronic data, and a quantity of underprivileged users in the user space, wherein the underprivileged users require access to the electronic application, the electronic file, or the electronic data but are not in the group; and assigning a first group in the ordering to the set of optimal groups.
22. The system of clause 21, wherein the set of optimal groups is further determined by: removing the first group from the group space and the users in the first group from the user space; and iteratively re-ordering, assigning, and removing one or more remaining groups from the group space and the users in the one or more remaining groups from the user space after assignment and removal of the first group; wherein the re-ordering, assigning, and removing the one or more remaining groups from the group space proceeds iteratively until: no remaining group breaches an access threshold, wherein the access threshold is determined based on the total quantity of the users in the group, the quantity of overprivileged users, the quantity of underprivileged users, a penalty for the overprivileged users, and a penalty for the underprivileged users; or the user space is empty.
23. The system of any of the previous embodiments, wherein one or both of the ordering and the access threshold are further determined by the processor based on the instructions, based on a penalty for the overprivileged users and a penalty for the underprivileged users.
24. The system of any of the previous embodiments, wherein the instructions, when executed by the processor, further cause the system to adjust one or both of the penalty for the overprivileged users and the penalty for the underprivileged users based on a required level of security associated with the electronic application, the electronic file, or the electronic data.
25. The system of any of the previous embodiments, wherein the penalty for the overprivileged users is increased responsive to the electronic application, the electronic file, or the electronic data requiring relatively high security compared to other electronic applications, electronic files, or electronic data.
26. The system of any of the previous embodiments, wherein the instructions, when executed by the processor, further cause the system to: group the users who remain in the user space after the iteratively re-ordering, assigning, and removing; and who require access to the electronic application, the electronic file, or the electronic data; into a group in the set of optimal groups, or into a new group in the set of optimal groups; or list the users who remain in the user space after the iteratively re-ordering, assigning, and removing; and who require access to the electronic application. the electronic file, or the electronic data.
27. The system of any of the previous embodiments, wherein the instructions, when executed by the processor, further cause the system to output one or more of: the set of optimal groups; the listing; and indications of risks associated with specific users or groups in the set of optimal groups, wherein the risks are determined based on an overprivileged rate for the set of optimal groups.
28. The system of any of the previous embodiments, wherein the outputting is configured to guide generation of one or more new security groups for the electronic application, the electronic file, or the electronic data.
29. The system of any of the previous embodiments, wherein the overprivileged users further comprise the users who have more permissions or access rights to the electronic application, the electronic file, or the electronic data than are necessary for current roles or responsibilities associated with the users.
30. The system of any of the previous embodiments, wherein determining the set of optimal groups further comprises filtering the groups in the group space based on predefined upper and lower group size thresholds prior to the ordering.
31. The system of any of the previous embodiments, wherein filtering the groups based on the predefined upper and lower size thresholds includes removing groups that exceed maximum upper size or fall below minimum lower size thresholds.
32. The system of any of the previous embodiments, wherein the upper and lower size thresholds are determined based on historical usage data for the electronic application, the electronic file, or the electronic data.
33. The system of any of the previous embodiments, wherein the grouping is based on user data that indicates user membership in one or more preexisting administrative registers.
34. The system of any of the previous embodiments, wherein the one or more preexisting administrative registers comprise group membership information and indicate electronic application, electronic file, or electronic data access rights for the users.
35. The system of any of the previous embodiments, wherein the users associated with the electronic application, the electronic file, or the electronic data comprise one or more of the users in one or more preexisting administrative registers associated with the electronic application, the electronic file, or the electronic data; active users who have used the electronic application, the electronic file, or the electronic data with a recent period of time; and the users whose organizational roles and responsibilities are associated with the electronic application, the electronic file, or the electronic data.
36. The system of any of the previous embodiments, wherein the instructions, when executed by the processor, further cause the system to: discover changes in one or more of: the one or more preexisting administrative registers, the active users, and the user roles and responsibilities; and re-group the users based on the changes.
37. The system of any of the previous embodiments, wherein the instructions, when executed by the processor, further cause the system to discover one or more additional user spaces associated with one or more additional electronic applications, electronic files, or electronic data in a directory; group additional users associated with the one or more additional electronic applications, electronic files, or electronic data into additional groups to form one or more additional group spaces; and determine one or more additional sets of optimal groups comprising the additional users permitted to access the one or more additional electronic applications, electronic files, or electronic data; for limiting access privileges to provide secure group-based access to the one or more additional electronic applications, electronic files, or electronic data.
38. The system of any of the previous embodiments, wherein the instructions, when executed by the processor, further cause the system to determine and output one or both of: a percentage of the users in the user space included in a group that is part of the set of optimal groups; and an overprivileged rate for the set of optimal groups.
39. The system of any of the previous embodiments, wherein ordering the groups in the group space comprises scoring the groups in the group space based on the total quantity of the users in a group, the quantity of overprivileged users in the group multiplied by a penalty for the overprivileged users, and the quantity of underprivileged users in the user space multiplied by a penalty for the underprivileged users.
40. The system of any of the previous embodiments, wherein the instructions, when executed by the processor, further cause the system to determine the penalty for the overprivileged users and the penalty for the underprivileged users by: predefining a range of possible values for the penalty for the overprivileged users and the penalty for the underprivileged users; scoring the groups in the group space based on different combinations of the possible values for the penalty for the overprivileged users and the penalty for the underprivileged users; for combinations of the possible values for the penalty for the overprivileged users and the penalty for the underprivileged users, evaluating the groups that would be in the set of optimal groups based on a total quantity of users from the user space in the groups that would be in the set of optimal groups. the quantity of overprivileged users in the groups that would be in the set of optimal groups, and the quantity of underprivileged users not in the groups that would be in the set of optimal groups; and determining the penalty for the overprivileged users and the penalty for the underprivileged users based on the evaluating such that a desired balance between the total quantity of users from the user space in the groups that would be in the set of optimal groups and overprivileged user minimization is achieved.
41. A non-transitory computer readable medium having instructions thereon, the instructions, when executed by a computer, causing the computer to perform operations for limiting access privileges to provide secure group-based access to an electronic application, the operations comprising: discovering a user space comprising users associated with the electronic application; grouping the users into groups to form a group space, with groups in the group space including users from the user space; determining a set of optimal groups from the group space comprising the users permitted to access the electronic application by: ordering the groups in the group space based on: a total quantity of the users in a group, a quantity of overprivileged users in the group, the overprivileged users comprising the users who do not require access to the electronic application, including the users who have more permissions or access rights to the electronic application than are necessary for current roles or responsibilities associated with the users, and a quantity of underprivileged users in the user space, the underprivileged users comprising the users who require access to the electronic application but who are not in the group; assigning a first group in the ordering to the set of optimal groups; removing the first group from the group space and the users in the first group from the user space; and iteratively re-ordering, assigning, and removing one or more remaining groups from the group space and the users in the one or more remaining groups from the user space after assignment and removal of the first group; wherein the re-ordering, assigning, and removing the one or more remaining groups from the group space proceeds iteratively until: no remaining group breaches an access threshold, wherein the access threshold is determined based on the total quantity of the users in the group, the quantity of overprivileged users, the quantity of underprivileged users, a penalty for the overprivileged users, and a penalty for the underprivileged users; or the user space is empty; and grouping the users who remain in the user space after the iteratively re-ordering, assigning, and removing; and who require access to the electronic application; into a group in the set of optimal groups, or into a new group in the set of optimal groups; or listing the users who remain in the user space after the iteratively re-ordering, assigning, and removing; and who require access to the electronic application.
42. The medium of embodiment 41, wherein one or both of the ordering and the access threshold are further determined based on a penalty for the overprivileged users and a penalty for the underprivileged users.
43. The medium of any of the previous embodiments, the operations further comprising adjusting one or both of the penalty for the overprivileged users and the penalty for the underprivileged users based on a required level of security associated with the electronic application.
44. The medium of any of the previous embodiments, wherein the penalty for the overprivileged users is increased responsive to the electronic application requiring relatively high security compared to other electronic applications.
45. The medium of any of the previous embodiments, the operations further comprising outputting one or more of: the set of optimal groups; the listing; and indications of risks associated with specific users or groups in the set of optimal groups, wherein the risks are determined based on an overprivileged rate for the set of optimal groups.
46. The medium of any of the previous embodiments, wherein the outputting is configured to guide generation of one or more new security groups for the electronic application.
47. The medium of any of the previous embodiments, wherein determining the set of optimal groups further comprises filtering the groups in the group space based on predefined upper and lower group size thresholds prior to the ordering.
48. The medium of any of the previous embodiments, wherein filtering the groups based on the predefined upper and lower size thresholds includes removing groups that exceed maximum upper size or fall below minimum lower size thresholds.
49. The medium of any of the previous embodiments, wherein the upper and lower size thresholds are determined based on historical usage data for the electronic application.
50. The medium of any of the previous embodiments, wherein the grouping is based on user data that indicates user membership in one or more preexisting administrative registers.
51. The medium of any of the previous embodiments, wherein the one or more preexisting administrative registers comprise group membership information and indicate electronic application access rights for the users.
52. The medium of any of the previous embodiments, wherein the users associated with the electronic application comprise one or more of the users in one or more preexisting administrative registers associated with the electronic application; active users who have used the electronic application with a recent period of time; and the users whose organizational roles and responsibilities are associated with the electronic application.
53. The medium of any of the previous embodiments, the operations further comprising: discovering changes in one or more of: the one or more preexisting administrative registers, the active users, and the user roles and responsibilities; and re-grouping the users based on the changes.
54. The medium of any of the previous embodiments, the operations further comprising discovering one or more additional user spaces associated with one or more additional electronic applications in a directory; grouping additional users associated with the one or more additional electronic applications into additional groups to form one or more additional group spaces; and determining one or more additional sets of optimal groups comprising additional users permitted to access the one or more additional electronic applications; for limiting access privileges to provide secure group-based access to the one or more additional electronic applications.
55. The medium of any of the previous embodiments, the operations further comprising determining and outputting one or both of: a percentage of the users in the user space included in a group that is part of the set of optimal groups; and an overprivileged rate for the set of optimal groups.
56. The medium of any of the previous embodiments, wherein ordering the groups in the group space comprises scoring the groups in the group space based on the total quantity of the users in a group, the quantity of overprivileged users in the group multiplied by a penalty for the overprivileged users, and the quantity of underprivileged users in the user space multiplied by a penalty for the underprivileged users.
57. The medium of any of the previous embodiments, the operations further comprising determining the penalty for the overprivileged users and the penalty for the underprivileged users by: predefining a range of possible values for the penalty for the overprivileged users and the penalty for the underprivileged users; scoring the groups in the group space based on different combinations of the possible values for the penalty for the overprivileged users and the penalty for the underprivileged users; for combinations of the possible values for the penalty for the overprivileged users and the penalty for the underprivileged users, evaluating the groups that would be in the set of optimal groups based on a total quantity of users from the user space in the groups that would be in the set of optimal groups, the quantity of overprivileged users in the groups that would be in the set of optimal groups, and the quantity of underprivileged users not in the groups that would be in the set of optimal groups; and determining the penalty for the overprivileged users and the penalty for the underprivileged users based on the evaluating such that a desired balance between the total quantity of users from the user space in the groups that would be in the set of optimal groups and overprivileged user minimization is achieved.
58. A non-transitory computer readable medium having instructions thereon, the instructions, when executed by a computer, causing the computer to perform operations for limiting access privileges to provide secure group-based access to an electronic application, the operations comprising: grouping users associated with the electronic application in a user space into groups to form a group space, with individual groups in the group space including at least one user from the user space; determining a set of optimal groups from the group space, the set of optimal groups comprising the users from the user space permitted to access the electronic application, the set of optimal groups determined by: ordering the groups in the group space based on: a total quantity of the users in a group, a quantity of overprivileged users in the group, wherein the overprivileged users do not require access to the electronic application because the overprivileged users have more permissions or access rights to the electronic application than are necessary for current roles or responsibilities associated with the overprivileged users, and a quantity of underprivileged users in the user space, wherein the underprivileged users require access to the electronic application but are not in the group; assigning a first group in the ordering to the set of optimal groups; removing the first group from the group space and the users in the first group from the user space; and iteratively re-ordering, assigning, and removing one or more remaining groups from the group space and the users in the one or more remaining groups from the user space after assignment and removal of the first group until: no remaining group breaches an access threshold, wherein the access threshold is determined based on the total quantity of the users in the group, the quantity of overprivileged users, the quantity of underprivileged users, a penalty for the overprivileged users, and a penalty for the underprivileged users; or the user space is empty.

1. A method for limiting access privileges to provide secure group-based access to an electronic application, the method comprising:
discovering a user space comprising users associated with the electronic application;
grouping the users into groups to form a group space, with the groups in the group space including the users from the user space; and
determining a set of optimal groups from the group space, the set of optimal groups comprising the users from the user space permitted to access the electronic application, the set of optimal groups determined by:
ordering the groups in the group space based on:
a total quantity of the users in a group,
a quantity of overprivileged users in the group, wherein the overprivileged users do not require access to the electronic application, and
a quantity of underprivileged users in the user space, wherein the underprivileged users require access to the electronic application but are not in the group;
assigning a first group in the ordering to the set of optimal groups;
removing the first group from the group space and the users in the first group from the user space; and
iteratively re-ordering, assigning, and removing one or more remaining groups from the group space and the users in the one or more remaining groups from the user space after assignment and removal of the first group.

2. The method of claim 1, wherein the re-ordering, assigning, and removing the one or more remaining groups from the group space proceeds iteratively until:
no remaining group breaches an access threshold, wherein the access threshold is determined based on the total quantity of the users in the group, the quantity of overprivileged users, and the quantity of underprivileged users; or
the user space is empty.

3. The method of claim 2, wherein one or both of the ordering and the access threshold are further determined based on a penalty for the overprivileged users and a penalty for the underprivileged users.

4. The method of claim 2, further comprising:
grouping the users who remain in the user space after the iteratively re-ordering, assigning, and removing; and who require access to the electronic application; into a group in the set of optimal groups, or into a new group in the set of optimal groups; or
listing the users who remain in the user space after the iteratively re-ordering, assigning, and removing; and who require access to the electronic application.

5. The method of claim 4, further comprising outputting one or more of:
the set of optimal groups;
the listing; and
indications of risks associated with specific users or groups in the set of optimal groups, wherein the risks are determined based on an overprivileged rate for the set of optimal groups.

6. The method of claim 1, wherein the overprivileged users further comprise the users who have more permissions or access rights to the electronic application than are necessary for current roles or responsibilities associated with the users.

7. The method of claim 1, wherein determining the set of optimal groups further comprises filtering the groups in the group space based on predefined upper and lower group size thresholds prior to the ordering.

8. The method of claim 7, wherein filtering the groups based on the predefined upper and lower size thresholds includes removing groups that exceed maximum upper size or fall below minimum lower size thresholds.

9. The method of claim 8, wherein the upper and lower size thresholds are determined based on historical usage data for the electronic application.

10. The method of claim 1, wherein the grouping is based on user data that indicates user membership in one or more preexisting administrative registers.

11. The method of claim 10, wherein the one or more preexisting administrative registers comprise group membership information and indicate electronic application access rights for the users.

12. The method of claim 1, wherein the users associated with the electronic application comprise one or more of the users in one or more preexisting administrative registers associated with the electronic application; active users who have used the electronic application with a recent period of time; and the users whose organizational roles and responsibilities are associated with the electronic application.

13. The method of claim 12, further comprising:
discovering changes in one or more of:
the one or more preexisting administrative registers,
the active users, and
the user roles and responsibilities; and
re-grouping the users based on the changes.

14. The method of claim 1, further comprising discovering one or more additional user spaces associated with one or more additional electronic applications in a directory; grouping additional users associated with the one or more additional electronic applications into additional groups to form one or more additional group spaces; and determining one or more additional sets of optimal groups comprising the additional users permitted to access the one or more additional electronic applications; for limiting access privileges to provide secure group-based access to the one or more additional electronic applications.

15. The method of claim 1, further comprising determining and outputting one or both of:
a percentage of the users in the user space included in a group that is part of the set of optimal groups; and
an overprivileged rate for the set of optimal groups.

16. A system, comprising:
a processor; and
memory storing instructions that, when executed by the processor, cause the system to:
determine a set of optimal groups from a group space, the set of optimal groups comprising users from a user space permitted to access an electronic application, an electronic file, or electronic data, the set of optimal groups determined by:
ordering the groups in the group space based on:
a total quantity of the users in a group,
a quantity of overprivileged users in the group, wherein the overprivileged users do not require access to the electronic application, the electronic file, or the electronic data, and
a quantity of underprivileged users in the user space, wherein the underprivileged users require access to the electronic application, the electronic file, or the electronic data but are not in the group; and
assigning a first group in the ordering to the set of optimal groups.

17. The system of claim 16, wherein the set of optimal groups is further determined by:
removing the first group from the group space and the users in the first group from the user space; and
iteratively re-ordering, assigning, and removing one or more remaining groups from the group space and the users in the one or more remaining groups from the user space after assignment and removal of the first group;
wherein the re-ordering, assigning, and removing the one or more remaining groups from the group space proceeds iteratively until:
no remaining group breaches an access threshold, wherein the access threshold is determined based on the total quantity of the users in the group, the quantity of overprivileged users, the quantity of underprivileged users, a penalty for the overprivileged users, and a penalty for the underprivileged users; or
the user space is empty.

18. The system of claim 17, wherein the instructions, when executed by the processor, further cause the system to:
group the users who remain in the user space after the iteratively re-ordering, assigning, and removing; and who require access to the electronic application, the electronic file, or the electronic data; into a group in the set of optimal groups, or into a new group in the set of optimal groups; or
list the users who remain in the user space after the iteratively re-ordering, assigning, and removing; and who require access to the electronic application, the electronic file, or the electronic data.

19. The system of claim 16, wherein the users associated with the electronic application, the electronic file, or the electronic data comprise one or more of the users in one or more preexisting administrative registers associated with the electronic application, the electronic file, or the electronic data; active users who have used the electronic application, the electronic file, or the electronic data with a recent period of time; and the users whose organizational roles and responsibilities are associated with the electronic application, the electronic file, or the electronic data; and wherein the instructions, when executed by the processor, further cause the system to:
discover changes in one or more of:
the one or more preexisting administrative registers,
the active users, and
the user roles and responsibilities; and
re-group the users based on the changes.

20. A non-transitory computer readable medium having instructions thereon, the instructions, when executed by a computer, causing the computer to perform operations for limiting access privileges to provide secure group-based access to an electronic application, the operations comprising:
grouping users associated with the electronic application in a user space into groups to form a group space, with individual groups in the group space including at least one user from the user space;
determining a set of optimal groups from the group space, the set of optimal groups comprising the users from the user space permitted to access the electronic application, the set of optimal groups determined by:
ordering the groups in the group space based on:
a total quantity of the users in a group,
a quantity of overprivileged users in the group, wherein the overprivileged users do not require access to the electronic application because the overprivileged users have more permissions or access rights to the electronic application than are necessary for current roles or responsibilities associated with the overprivileged users, and
a quantity of underprivileged users in the user space, wherein the underprivileged users require access to the electronic application but are not in the group;
assigning a first group in the ordering to the set of optimal groups;
removing the first group from the group space and the users in the first group from the user space; and
iteratively re-ordering, assigning, and removing one or more remaining groups from the group space and the users in the one or more remaining groups from the user space after assignment and removal of the first group until:
no remaining group breaches an access threshold, wherein the access threshold is determined based on the total quantity of users in the group, the quantity of overprivileged users, the quantity of underprivileged users, a penalty for the overprivileged users, and a penalty for the underprivileged users; or
the user space is empty.
